(19) United States
(12) Patent Application Publication
(10) Pub. No.: US 2024/0412483 A1
(43) Pub. Date: Dec. 12, 2024

(54) IMAGE PROCESSING APPARATUS, IMAGE PROCESSING SYSTEM, AND IMAGE PROCESSING METHOD

(71) Applicant: PFU LIMITED, Kahoku-shi (JP)

(72) Inventors: Masayoshi Hayashi, Kahoku-shi (JP); Kazutoshi Miyamura, Kahoku-shi (JP)

(21) Appl. No.: 18/668,713

(22) Filed: May 20, 2024

(30) Foreign Application Priority Data
Jun. 6, 2023 (JP) 2023-093110

(51) Int. Cl. G06V 10/74

(52) U.S. Cl. CPC G06V 10/761

(57) ABSTRACT

An image processing apparatus includes circuitry. The circuitry set a profile including setting values of setting items regarding at least one of imaging processing, image processing, or conveyance processing. The circuitry acquires an input image in which a medium is imaged. The circuitry identifies characteristic information pieces respectively relating to the setting items in the input image. The circuitry determines whether the profile matches a characteristic of the input image by comparing the characteristic information pieces in the input image with information based on the setting value of each setting items included in the profile. The circuitry notifies information regarding a determination result or stop an image generation process by an apparatus that generated the input image in a case where the determination result indicates that the profile does not match the characteristic of the input image.

### CROSS-REFERENCE TO RELATED APPLICATION

This patent application is based on and claims priority pursuant to 35 U.S.C. § 119 (a) to Japanese Patent Application No. 2023-093110, filed on Jun. 6, 2023, in the Japan Patent Office, the entire disclosure of which is hereby incorporated by reference herein.

### BACKGROUND

### Technical Field

The present disclosure relates to an image processing apparatus, an image processing system, and an image processing method.

### Related Art

Currently, image processing apparatuses such as a scanner, which scans a plurality of media to generate images while sequentially conveying the media, have been used for imaging of various types of media in a wide variety of applications. The image quality required of such an image processing apparatus differs depending on, for example, its purpose and the type of media to be read. In general, in the image processing apparatus, settings of various items regarding to imaging processing, image processing or conveying processing of the media, such as a size or color, can be configured to generate an appropriate image according to, for example, the application or type of media. However, if the settings are wrong, the image processing apparatus may fail to acquire an appropriate image.

An image forming apparatus that scans a document and copies the scanned document in a copy mode designated by a user in advance is known. The image forming apparatus identifies the type of a document. When a copy mode corresponding to the identified type is different from the copy mode designated by the user in advance, the image forming apparatus inquires of the user which copy mode is to be used to copy the document. The image forming apparatus copies the document in a copy mode according to the inquiry result.

### SUMMARY

In one aspect, an image processing apparatus includes circuitry. The circuitry sets a profile including a setting value of each of a plurality of setting items regarding at least one of imaging processing, image processing, or conveyance processing. The circuitry acquires an input image in which a medium is imaged according to the profile. The circuitry identifies a plurality of pieces of characteristic information respectively relating to the plurality of setting items in the input image. The circuitry determines whether the profile matches a characteristic of the input image by comparing the plurality of pieces of characteristic information in the input image with information based on the setting value of each of the plurality of setting items included in the profile being set. The circuitry notifies information regarding a determination result or stop an image generation process by an apparatus that generated the input image in a case where the determination result indicates that the profile does not match the characteristic of the input image.

In another aspect, an image processing system includes an image reading apparatus and an information processing apparatus. The image processing system includes circuitry. The circuitry sets a profile including a setting value of each of a plurality of setting items regarding at least one of imaging processing, image processing, or conveyance processing. The circuitry acquires an input image in which a medium is imaged according to the profile. The circuitry identifies a plurality of pieces of characteristic information respectively relating to the plurality of setting items in the input image. The circuitry determines whether the profile matches a characteristic of the input image by comparing the plurality of pieces of characteristic information in the input image with information based on the setting value of each of the plurality of setting items included in the profile being set. The circuitry notifies information regarding a determination result or stop an image generation process by an apparatus that generated the input image in a case where the determination result indicates that the profile does not match the characteristic of the input image.

In another aspect, an image processing method includes setting a profile including a setting value of each of a plurality of setting items regarding at least one of imaging processing, image processing, or conveyance processing. The method includes acquiring an input image in which a medium is imaged according to the profile. The method includes identifying a plurality of pieces of characteristic information respectively relating to the plurality of setting items in the input image. The method includes determining whether the profile matches a characteristic of the input image by comparing the plurality of pieces of characteristic information in the input image with information based on the setting value of each of the plurality of setting items included in the profile being set. The method includes notifying information regarding a determination result or stop an image generation process by an apparatus that generated the input image in a case where the determination result indicates that the profile does not match the characteristic of the input image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram schematically illustrating a configuration of an image processing system according to an embodiment of the present disclosure;

FIG. 2 is a perspective view of an image reading apparatus of the image processing system illustrated in FIG. 1;

FIG. 3 is a diagram illustrating a conveyance passage inside the image reading apparatus illustrated in FIG. 2;

FIG. 4 is a block diagram schematically illustrating a configuration of the image reading apparatus illustrated in FIG. 2;

FIG. 5 is a schematic diagram illustrating an example data structure of a profile table;

FIG. 6 is a diagram schematically illustrating configurations of a first storage device and a first processing circuit of the image reading apparatus illustrated in FIG. 4;

FIG. 7 is a block diagram schematically illustrating a configuration of the information processing apparatus of the image processing system illustrated in FIG. 1;

FIG. 8 is a flowchart of an image reading process performed by the image reading apparatus illustrated in FIG. 6;

FIG. 9 is another flowchart of the image reading process performed by the image reading apparatus illustrated in FIG. 6;

FIG. 10 is a schematic diagram illustrating an example of characteristic information;

FIG. 11 is a schematic diagram illustrating an example of notification data;

FIG. 12 is a flowchart of an image reading process according to another embodiment;

FIG. 13 is a schematic diagram illustrating an example data structure of a history table;

FIG. 14 is a schematic diagram illustrating an example data structure of a tabulation table;

FIG. 15 is a block diagram schematically illustrating a configuration of a first processing circuit according to another embodiment;

FIG. 16 is a diagram schematically illustrating configurations of a second storage device and a second processing circuit according to a still another embodiment; and

FIG. 17 is a block diagram schematically illustrating a configuration of a second processing circuit according to a still another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image processing apparatus, an image processing system, an image processing method, and a program according to embodiments of the present disclosure are described below with reference to the drawings. The technical scope of the present disclosure, however, is not limited to the embodiments described below but includes the scope of the appended claims and the equivalents thereof.

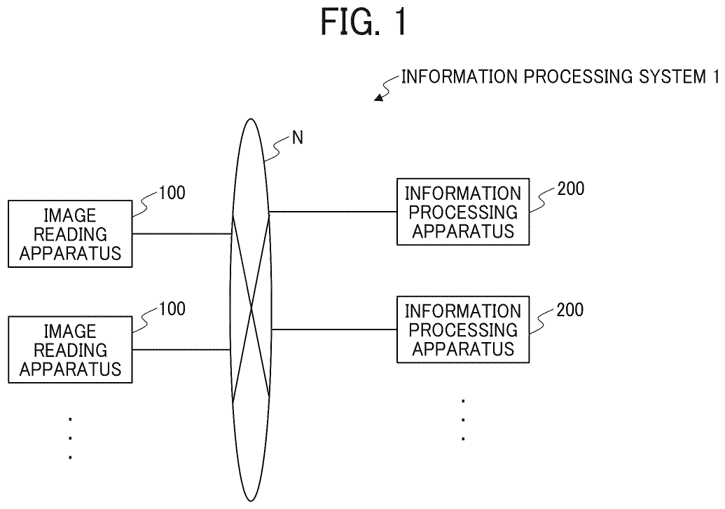

FIG. 1 is a diagram schematically illustrating a configuration of an image processing system 1 according to an embodiment.

As illustrated in FIG. 1, the image processing system 1 includes one or more image reading apparatuses 100 and one or more information processing apparatuses 200. The image reading apparatus 100 and the information processing apparatus 200 are communicably connected to each other through a network N. The network N is, for example, the Internet or an intranet. The image reading apparatus 100 and the information processing apparatus 200 are examples of an image processing apparatus.

The image reading apparatus 100 is, for example, an automatic document feeder (ADF) type scanner device that images a medium such as a document while conveying media. Examples of the medium include a sheet of plain paper, a sheet of thin paper, a sheet of thick paper, and a card. Examples of the medium further include various types of media such as a receipt, a business card, an invoice, and a delivery note. Alternatively, the image reading apparatus 100 may be, for example, a facsimile machine, a copier, or a multifunction peripheral (MFP).

The information processing apparatus 200 is, for example, a personal computer, a laptop personal computer, a tablet computer, or a smartphone. The information processing apparatus 200 may be a server provided in a cloud network.

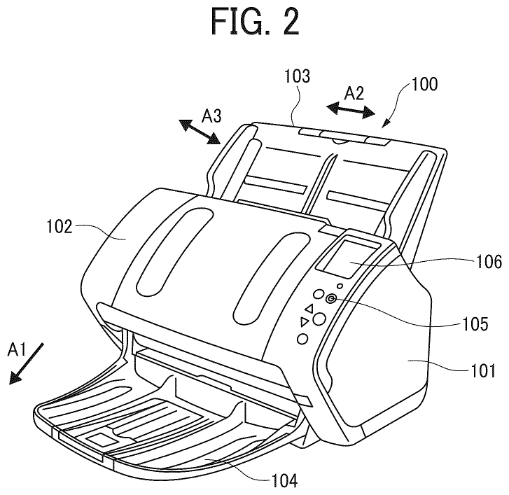

FIG. 2 is a perspective view of the image reading apparatus 100.

The image reading apparatus 100 includes, for example, a lower housing 101, an upper housing 102, a feed table 103, an ejection table 104, a first input device 105, and a first display device 106.

The upper housing 102 is disposed at a position covering the upper surface of the image reading apparatus 100, and is engaged with the lower housing 101 with a hinge such that the upper housing 102 can be opened and closed to, for example, remove a jammed medium or clean the inside of the image reading apparatus 100.

The feed table 103 is engaged with the lower housing 101 such that the media to be conveyed can be placed on the feed table 103. The ejection table 104 is engaged with the lower housing 101 such that the media ejected from an ejection port can be placed on the ejection table 104.

The first input device 105 includes an input device such as keys and an interface circuit that acquires signals from the input device. The first input device 105 receives an input operation performed by a user and outputs an operation signal corresponding to the input operation performed by the user. The first display device 106 includes a display and an interface circuit that outputs image data to the display and displays an image on the display according to the image data. Examples of the display include a liquid crystal display and an organic electro-luminescence (EL) display.

In FIG. 2, arrow A1 indicates the direction in which media are conveyed (may be referred to as a “media conveyance direction A1” in the following description). Arrow A2 indicates the width direction of the image reading apparatus 100 (may be referred to as a “width direction A2” in the following description) orthogonal to the media conveyance direction A1. Arrow A3 indicates the height direction orthogonal to the media conveyance direction A1 and the width direction A2. In the following description, the term “upstream” refers to upstream in the media conveyance direction A1, and the term “downstream” refers to downstream in the media conveyance direction A1.

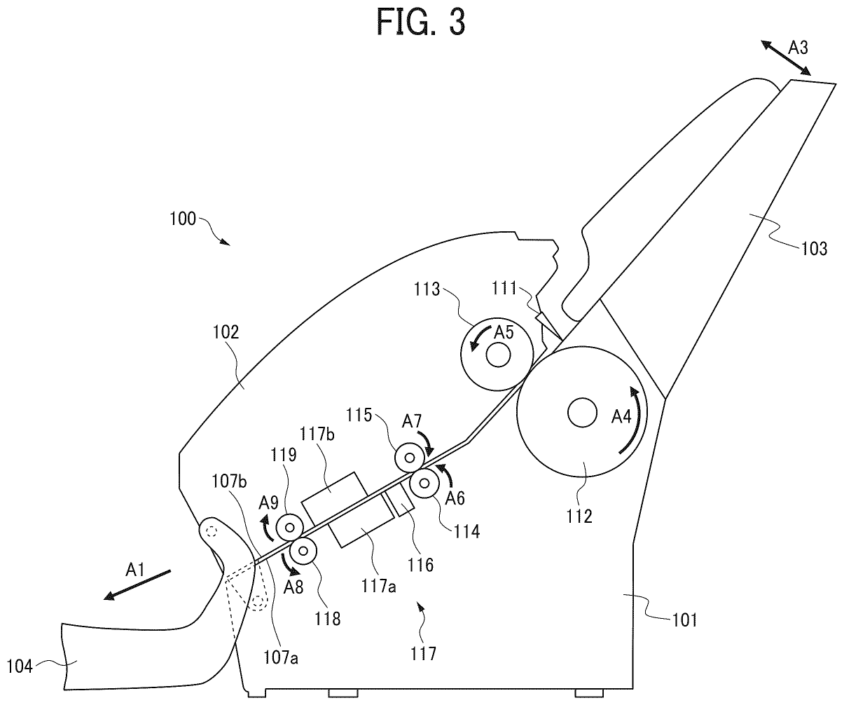

FIG. 3 is a diagram illustrating a conveyance passage inside the image reading apparatus 100.

The image reading apparatus 100 includes, along a conveyance passage, includes a first media sensor 111, a feed roller 112, a separation roller 113, a first conveyance roller 114, a second conveyance roller 115, a second media sensor 116, an imaging device 117, a third conveyance roller 118, and a fourth conveyance roller 119. The number of each of the above rollers is not limited to one, and may be two or more. When one or more of the above rollers are formed of multiple rollers, the multiple rollers are arranged at intervals in the width direction A2. The feed roller 112, the separation roller 113, the first conveyance roller 114, the second conveyance roller 115, the third conveyance roller 118, and the fourth conveyance roller 119 are collectively an example of a conveying device, and sequentially convey media.

The image reading apparatus 100 includes a so-called straight path. The upper face of the lower housing 101 forms a lower guide 107a for the media conveyance passage. The lower face of the upper housing 102 forms an upper guide 107b for the media conveyance passage.

The first media sensor 111 is disposed upstream from the feed roller 112 and the separation roller 113. The first media sensor 111 includes a contact detection sensor and detects whether a medium is placed on the feed table 103. The first media sensor 111 generates a first media signal of which the signal value changes depending on whether a medium is placed on the feed table 103 and outputs the generated first media signal. The first media sensor 111 is not limited to a contact detection sensor. The first media sensor 111 may be any other sensor that can detect the presence of a medium. Examples of any other sensor include an optical detection sensor.

The feed roller 112 is disposed in the lower housing 101 and feeds the media from to the top from the feed table 103. The separation roller 113 is a so-called brake roller or retard roller. The separation roller is disposed in the upper housing 102 and opposite to the feed roller 112. The feed roller 112 and the separation roller 113 function as separators that separate the media.

The first conveyance roller 114 and the second conveyance roller 115 are disposed downstream from the feed roller 112 and the separation roller 113 and opposite to each other. The first conveyance roller 114 and the second conveyance roller 115 convey the media fed by the feed roller 112 and the separation roller 113 to the imaging device 117.

The second media sensor 116 is disposed downstream from the first conveyance roller 114 and the second conveyance roller 115 and upstream from the imaging device 117, and detects a medium conveyed to the position where the second media sensor 116 is disposed. The second media sensor 116 includes a light emitter, a light receiver, and a light guide tube. The light emitter and the light receiver are disposed on one side of the media conveyance passage (e.g., the lower housing 101 side). The light guide tube is disposed at a position opposite to the light emitter and the light receiver across the media conveyance passage (e.g., the upper housing 102 side). The light emitter is, for example, a light emitting diode (LED) and emits light toward the media conveyance passage. By contrast, the light receiver is, for example, a photodiode and receives light that is emitted by the light emitter and guided by the light guide tube. When the medium is present at a position opposite to the second media sensor 116, the light emitted from the light emitter is blocked by the medium, and therefore the light receiver does not detect the light emitted from the light emitter. Based on the intensity of the light received, the light receiver generates and outputs a second media signal of which the signal value changes between when a medium is present at the position of the second media sensor 116 and when a medium is absent at the position of the second media sensor 116. The number of the second media sensor 116 may be two or more. When the number of the second media sensor 116 is two or more, the second media sensors 116 are arranged at intervals in the width direction A2.

A reflector such as a mirror may be used instead of the light guide tube. Further, the light emitter and the light receiver may be disposed opposite to each other across the media conveyance passage. Further, the second media sensor 116 may detect the presence of the medium with, for example, a contact sensor that causes a predetermined current to flow when a medium is in contact with the contact sensor or when no medium is in contact with the contact sensor.

The imaging device 117 is an example of an imaging unit. The imaging device 117 is disposed downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are disposed near the media conveyance passage and opposite to each other across the media conveyance passage.

The first imaging device 117a includes a light source and a contact image sensor (CIS) line sensor. The CIS line sensor employs an equal-magnification optical system and includes complementary metal oxide semiconductor (CMOS) imaging elements aligned linearly in the main-scanning direction. The first imaging device 117a further includes a lens and an analog-to-digital (A/D) converter. The lens forms an image on the imaging elements. The A/D converter amplifies the electrical signals output from the imaging elements and performs analog-to-digital (A/D) conversion. The first imaging device 117a obtains an input image by imaging the front side of each of the media sequentially conveyed by the conveying device, and outputs the input image.

In substantially the same manner, the second imaging device 117b includes a light source and a CIS line sensor. The CIS line sensor employs an equal-magnification optical system and includes CMOS imaging elements aligned linearly in the main-scanning direction. The second imaging device 117b further includes a lens and an A/D converter. The lens forms an image on the imaging elements. The A/D converter amplifies the electrical signals output from the imaging elements and performs analog-to-digital (A/D) conversion. The second imaging device 117b obtains an input image by imaging the back side of each of the media sequentially conveyed by the conveying device, and outputs the input image.

Alternatively, the image reading apparatus 100 may include either the first imaging device 117a or the second imaging device 117b to read only one side of the medium. The line sensor may be, instead of the CIS employing the equal-magnification optical system and including CMOSs as imaging elements, a CIS employing the equal-magnification optical system and including charge-coupled devices (CCDs) as imaging elements. Alternatively, a line sensor employing a reduction optical system and including a CMOS or CCD imaging element may be used.

The third conveyance roller 118 and the fourth conveyance roller 119 are disposed downstream from the imaging device 117 and opposite to each other. The third conveyance roller 118 and the fourth conveyance roller 119 eject the media conveyed by the first conveyance roller 114 and the second conveyance roller 115 onto the ejection table 104. The third conveyance roller 118 and the fourth conveyance roller 119 may be provided so as to change a direction in which the media are ejected under control of a first processing circuit described below.

As the feed roller 112 rotates in the direction of the arrow A4 in FIG. 3, the medium is conveyed from the feed table 103 in the media conveyance direction A1 between the lower guide 107a and the upper guide 107b. The separation roller 113 rotates or stops in the direction of the arrow A5 in FIG. 3 when conveying the media. Due to the action of the feed roller 112 and separation roller 113, when a plurality of media is placed on the feed table 103, only the medium in contact with the feed roller 112 among the media placed on the feed table 103 is separated. This prevents the feeding of a medium other than the separated medium. In other words, the multiple feeding is prevented.

The medium is fed between the first conveyance roller 114 and the second conveyance roller 115 while being guided by the lower guide 107a and the upper guide 107b. As the first conveyance roller 114 rotates in the direction of the arrow A6 in FIG. 3 and the second conveyance roller 115 rotates in the direction of the arrow A7 in FIG. 3, the medium is fed between the first imaging device 117a and the second imaging device 117b. As the third conveyance roller 118 rotates in the direction of the arrow A8 in FIG. 3 and the fourth conveyance roller 119 rotates in the direction of the arrow A9 in FIG. 3, the medium read by the imaging device 117 is ejected to the ejection table 104.

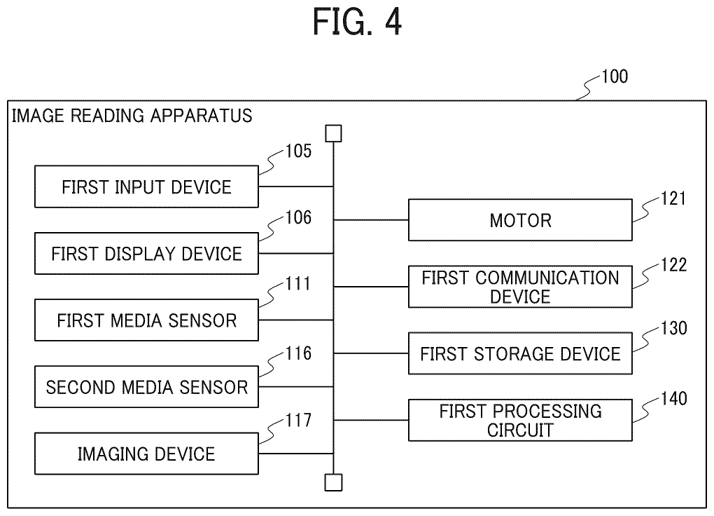

FIG. 4 is a block diagram schematically illustrating a configuration of the image reading apparatus 100.

In addition to the configuration described above, the image reading apparatus 100 includes a motor 121, a first communication device 122, a first storage device 130, and a first processing circuit 140.

The motor 121 includes one or a plurality of motors. The motor 121 rotates the feed roller 112, the separation roller 113, the first conveyance roller 114, the second conveyance roller 115, the third conveyance roller 118, and the fourth conveyance roller 119 according to a control signal from the first processing circuit 140 to perform the conveyance operation of the media. One of the first conveyance roller 114 and the second conveyance roller 115 may be a driven roller rotated by the rotation of the other roller. One of the third conveyance roller 118 and the fourth conveyance roller 119 may be a driven roller rotated by the rotation of the other roller. The motor 121 changes the direction in which the media are ejected by the third conveyance roller 118 and the fourth conveyance roller 119 according to a control signal from the first processing circuit 140.

The first communication device 122 includes an antenna and a wireless communication interface circuit. The antenna transmits and receives wireless signals. The wireless communication interface circuit transmits and receives signals through a wireless communication line according to a communication protocol such as a wireless local area network (LAN) protocol. The first communication device 122 communicates with the information processing apparatus 200. The first communication device 122 transmits and receives various images and information to and from the information processing apparatus 200 according to an instruction from the first processing circuit 140. The first communication device 122 may include a wired communication interface circuit according to a communication protocol such as the Transmission Control Protocol/Internet Protocol (TCP/IP), and may be connected to the information processing apparatus 200 through a network. The first communication device 122 may include an interface circuit compatible with a serial bus such as a universal serial bus (USB) and may be connected to the information processing apparatus 200 through a wired cable such as a USB cable.

The first storage device 130 includes memories such as a random-access memory (RAM) and a read-only memory (ROM); a fixed disk device such as a hard disk; or a portable memory such as a flexible disk or an optical disc. The first storage device 130 stores, for example, computer programs, databases, and tables used for various processes performed by the image reading apparatus 100. The computer programs may be installed in the first storage device 130 from a computer-readable portable recording medium using, for example, a known setup program. Examples of the portable recording medium includes a compact disc-read-only memory (CD-ROM) and a digital versatile disc-read-only memory (DVD-ROM). The computer program may be distributed from, for example, a server and installed in the first storage device 130.

Further, the first storage device 130 stores a profile table as data. Information regarding a profile is stored in the profile table. The profile is a setting regarding imaging processing, image processing, or conveyance processing. The profile is set by a user according to, for example, the usage of an image to be generated or the type of medium to be imaged. The profile includes setting values respectively for multiple setting items regarding imaging processing, image processing, or conveyance processing. A detailed description is given later of the profile table.

The first processing circuit 140 operates according to a program prestored in the first storage device 130. The first processing circuit 140 is, for example, a central processing unit (CPU). Alternatively, as the first processing circuit 140, for example, a digital signal processor (DSP), a large scale integration (LSI), an application-specific integrated circuit (ASIC), or a field-programmable gate array (FPGA) may be used.

The first processing circuit 140 is connected to, for example, the first input device 105, the first display device 106, the first media sensor 111, the second media sensor 116, the imaging device 117, the motor 121, the first communication device 122, and the first storage device 130, and controls each of these components. The first processing circuit 140 sets a profile specified by a user via the first input device 105 or the first communication device 122. The first processing circuit 140 controls, for example, the driving of the motor 121 and the imaging by the imaging device 117 according to the profile being set and acquires an input image. The first processing circuit 140 determines whether the profile being set matches the characteristics of the input image. When the determination result indicates that the profile does not match the characteristics of the input image, the first processing circuit 140 notifies a user of information regarding the determination result or stops an image generation process.

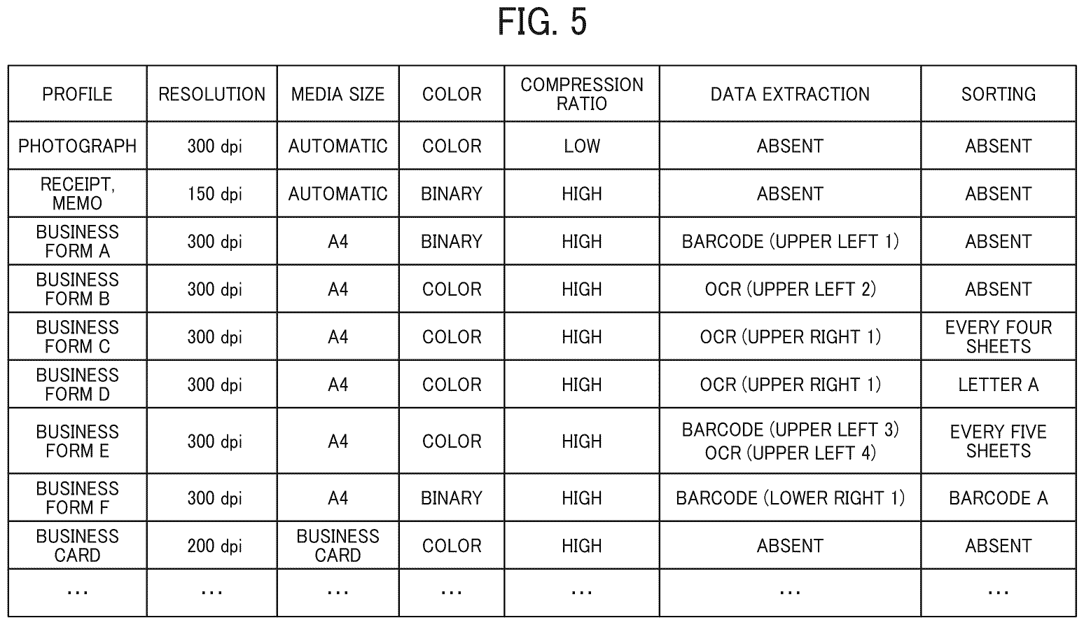

FIG. 5 is a schematic diagram for describing a data structure of the profile table.

As illustrated in FIG. 5, the profile table stores, for each of one or more profiles, for example, a setting value of each of multiple setting items in association with other. The profile includes, for example, a photograph, a receipt, a memo, a business form, and a business card.

The setting items are items regarding imaging processing, image processing, or conveyance processing. The setting items are items specifying, for example, content of an operation by the image reading apparatus 100 of conveying or imaging a medium or image processing to be executed on the obtained image. The setting items include resolution, media size, color, compression ratio, data extraction, and sorting. The resolution, media size, and color are settings regarding the imaging processing. Further, the resolution, media size, color, compression ratio, and data extraction are settings regarding the image processing. Furthermore, the sorting is a setting regarding the conveyance processing.

The resolution is a setting of the resolution of an image to be generated. The setting value of the resolution is, for example, 150 dots per inch (dpi), 200 dpi, 300 dpi, 600 dpi, or 1200 dpi. The image reading apparatus 100 generates an image of which resolution is the resolution being by setting, for example, the media conveyance speed, the imaging timing (time interval) by the imaging device 117, and the position of the imaging element in the line sensor used for imaging in the imaging processing. Further, the image reading apparatus 100 generates an image of which resolution is the resolution being set, by executing, in the image processing, thinning or interpolation of the image generated in the imaging processing.

The media size is the setting of the size of the medium included in an image to be generated. Examples of the setting value of the media size include business card size, letter size, A4 size, A3 size, and automatic. When the automatic is set, the image reading apparatus 100 automatically detects the size of a conveyed medium on the basis of the detection result of the medium by the second media sensor 116 or the input image generated by the imaging device 117. The image reading apparatus 100 generates an image including a medium having the media size being set, by setting, for example, the timing at which the imaging device 117 finishes the imaging, and the position of the imaging element in the line sensor used for the imaging in the imaging processing. Further, the image reading apparatus 100 generates an image including a medium having the media size being set, by executing, in the image processing, cropping of the image generated in the imaging processing.

The color is the setting of the color of an image to be generated. Examples of the setting value of the color include a binary value, gray scale, and a color. The image reading apparatus 100 changes the color of an image to be generated by setting, for example, the color of the light emitted by the light source of the imaging device 117 and the gradation range converted by the A/D converter in the imaging processing. Further, the image reading apparatus 100 changes the color of an image to be generated by, for example, executing, in the image processing, gray scale conversion or binarization of the color image generated in the imaging processing.

The compression ratio is the setting for performing image compression such as Joint Photographic Experts Group (JPEG) on an image to be generated. The setting value of the compression ratio includes a quantization value or a compression degree (e.g., high, medium, low) in image compression. The image reading apparatus 100 generates an image compressed at the compression ratio being set, by executing image compression on the input image at the compression ratio being set in the image processing.

The data extraction is the setting for extracting data such as characters or a barcode from an image to be generated. The setting value of the data extraction includes a type of data to be extracted such as characters or a barcode and a position from which each data item is extracted in the image. The image reading apparatus 100 extracts the data being set from the position being set in the input image in the image processing.

The sorting is a setting for separating media ejected on the ejection table 104. The setting value of the sorting includes the number of media to be collected into one group or the characteristics of a medium (a so-called separating sheet) arranged at the top of the media to be collected into one group. Examples of the characteristics of the separating sheet include the presence of a predetermined barcode or character. The image reading apparatus 100 separates the ejected medium by changing the direction in which the media are ejected by the third conveyance roller 118 and the fourth conveyance roller 119 every time the set number of media are conveyed when ejecting the medium.

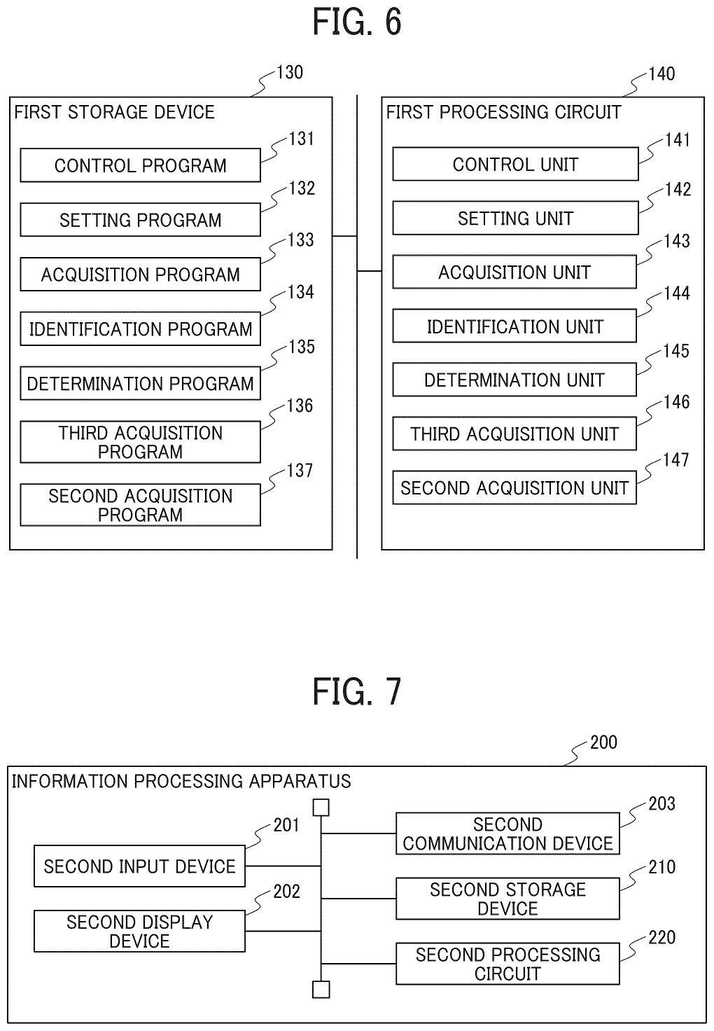

FIG. 6 is a diagram schematically illustrating configurations of the first storage device 130 and the first processing circuit 140.

As illustrated in FIG. 6, the first storage device 130 stores a control program 131, a setting program 132, an acquisition program 133, an identification program 134, a determination program 135, a third acquisition program 136, and a second acquisition program 137. These programs are functional modules implemented by software operating on a processor. The first processing circuit 140 reads the programs stored in the first storage device 130 and operates according to the read programs, thereby functioning as a control unit 141, a setting unit 142, an acquisition unit 143, an identification unit 144, a determination unit 145, a third acquisition unit 146, and a second acquisition unit 147.

FIG. 7 is a block diagram schematically illustrating a configuration of the information processing apparatus 200.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device. The second input device 201 outputs a signal corresponding to an operation by a user to the second processing circuit 220.

The second display device 202 includes a display including, for example, liquid crystal or organic EL, and an interface circuit that outputs image data to the display. The second display device 202 displays various types of information on the display according to an instruction from the second processing circuit 220.

The second communication device 203 includes an antenna that transmits and receives wireless signals, and a wireless communication interface circuit that transmits and receives signals through a wireless communication line according to a predetermined communication protocol such as a wireless LAN protocol. The second communication device 203 communicates with the image reading apparatus 100. The second communication device 203 transmits and receives various images and information to and from the image reading apparatus 100 according to an instruction from the second processing circuit 220. The second communication device 203 may include a wired communication interface circuit according to a communication protocol such as the TCP/IP, and may be connected to the image reading apparatus 100 through a network. The second communication device 203 may include an interface circuit compatible with a serial bus such as a USB and may be connected to the image reading apparatus 100 through a wired cable such as a USB cable.

The second storage device 210 includes memories such as a RAM and a ROM; a fixed disk device such as a hard disk; or a portable memory such as a flexible disk or an optical disc. The second storage device 210 stores, for example, computer programs, databases, and tables used for various processes performed by the information processing apparatus 200. The computer programs may be installed in the second storage device 210 from a computer-readable portable recording medium, such as a CD-ROM or a DVD-ROM, using, for example, a known setup program. Further, the computer programs may be distributed, for example, from a server and installed in the second storage device 210.

The second processing circuit 220 operates according to a program prestored in the second storage device 210. The second processing circuit 220 is, for example, a CPU. As the second processing circuit 220, for example, a DSP, a LSI, an ASIC, or a FPGA may be used.

The second processing circuit 220 is connected to, for example, the second input device 201, the second display device 202, the second communication device 203, and the second storage device 210, and controls each of these components. The second processing circuit 220 performs, for example, control of transmitting and receiving data to and from the image reading apparatus 100 via the second communication device 203, input control of the second input device 201, and display control of the second display device 202.

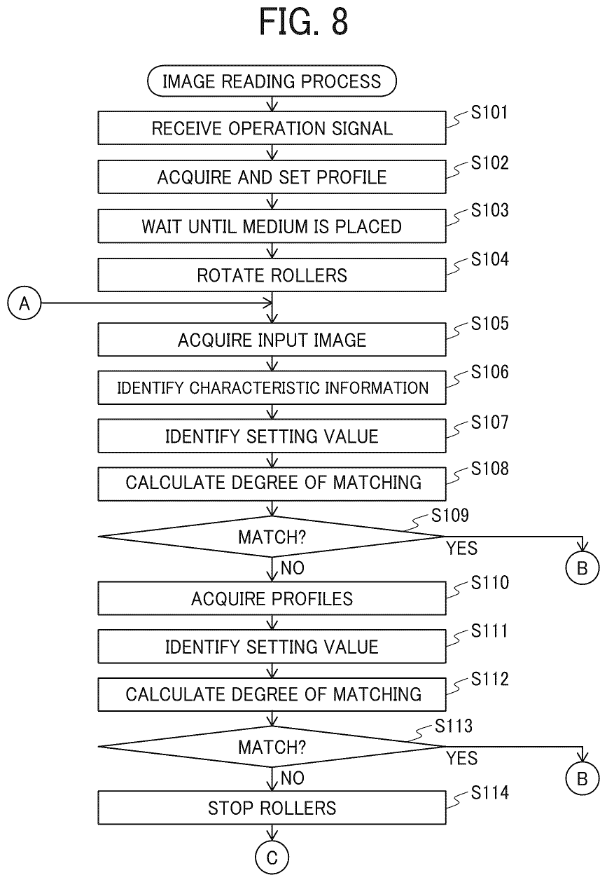

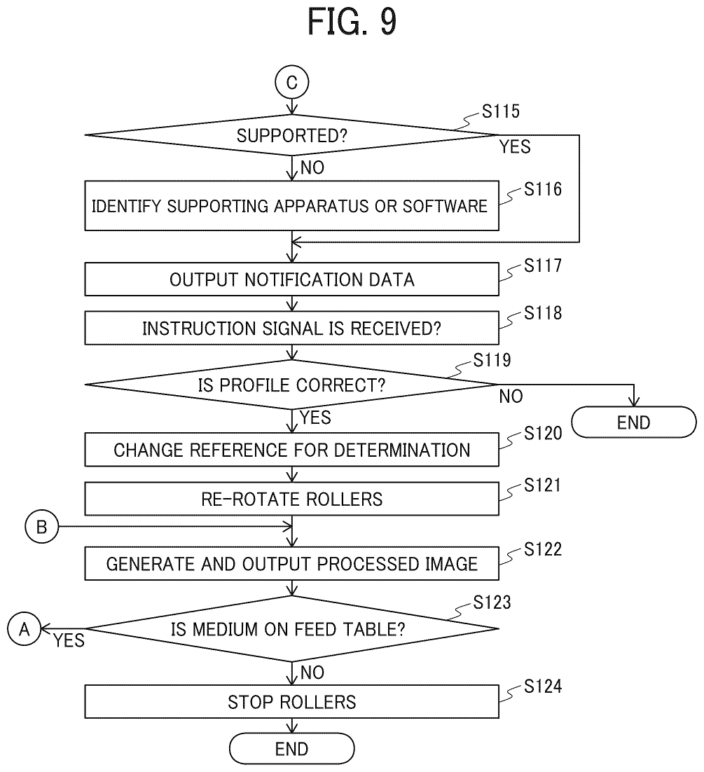

FIG. 8 is a flowchart of an example of an operation of an image reading process. FIG. 9 is a continuation of the flowchart of FIG. 8.

A description is given below of the image reading process performed by the image reading apparatus 100 with reference to the flowcharts of FIG. 8 of FIG. 9. The operation process described below is executed, for example, by the first processing circuit 140 in cooperation with the components of the image reading apparatus 100 according to the program prestored in the first storage device 130.

The control unit 141 waits until the control unit 141 receives an operation signal instructing the reading of media from the first input device 105 or the first communication device 122 (step S101). The operation signal is output when the user inputs an instruction to read media using the first input device 105 or the information processing apparatus 200. The operation signal includes a profile designated by the user using the first input device 105 or the information processing apparatus 200 along with the instruction to read media.

Subsequently, the setting unit 142 acquires the profile included in the operation signal, sets the acquired profile in the first storage device 130, and configure the settings of, for example, the imaging device 117 and the motor 121 to generate an input image corresponding to the acquired profile (step S102). The setting unit 142 configure the settings of, for example, the imaging device 117 and the motor 121 to generate the input image having a quality equal to or higher than the quality of an image according to the profile being set. For example, the setting unit 142 configure settings of, for example, the imaging device 117 and the motor 121 to generate the input image of which the resolution is the maximum resolution supported by the image reading apparatus 100, the media size is the maximum media size supported by the image reading apparatus 100, and the color is color. Accordingly, the image reading apparatus 100 can appropriately determine whether the profile being set matches the characteristic of the input image on the basis of the input image in a process described later.

The profile may be designated by the user before inputting the instruction to read medium and stored in the first storage device 130, instead of being designated along with the instruction to read the medium. In such a case, the setting unit 142 acquires the profile by reading the profile from the first storage device 130. Further, the control unit 141 sets (initializes) the media number of the medium to be conveyed to 1.

Subsequently, the control unit 141 waits until the media are placed on the feed table 103 (step S103). The control unit 141 acquires a first media signal from the first media sensor 111 and determines whether media are placed on the feed table 103 on the basis of the acquired first media signal.

Subsequently, the control unit 141 drives the motor 121 to rotate the feed roller 112, the separation roller 113, the first conveyance roller 114, the second conveyance roller 115, the third conveyance roller 118, and/or the fourth conveyance roller 119 (step S104). Thus, the control unit 141 feeds and conveys the media from the feed table 103. The control unit 141 controls the motor 121 so that an input image according to the profile acquired in step S102 is generated. The control unit 141 controls the motor 121 in particular to rotate at a speed that implements generation of an image with the resolution specified by the profile.

Subsequently, the acquisition unit 143 acquires an input image obtained by imaging a medium being conveyed from the imaging device 117 (step S105).

For example, the acquisition unit 143 determines whether the leading end of the medium has passed the position of the second media sensor 116 on the basis of the second media signal received from the second media sensor 116. The acquisition unit 143 acquires the second media signal periodically from the second media sensor 116 and determines that the leading end of the medium has passed the position of the second media sensor 116 when the signal value of the second media signal changes from a value indicating the absence of a medium to a value indicating the presence of a medium. The acquisition unit 143 controls the imaging device 117 to start imaging when the leading end of the medium has passed the position of the second media sensor 116. The control unit 141 controls the imaging device 117 to generate the input image according to the profile acquired in step S102.

Thereafter, the acquisition unit 143 controls the imaging device 117 to finish imaging when the medium has been conveyed by the amount obtained by adding a margin to the media size indicated by the profile acquired in step S102. The acquisition unit 143 may control the imaging device 117 to finish imaging when the trailing end of the medium has passed through the imaging position of the imaging device 117. For example, the acquisition unit 143 determines whether the trailing end of the medium has passed the position of the second media sensor 116 on the basis of the second media signal received from the second media sensor 116. The acquisition unit 143 acquires the second media signal periodically from the second media sensor 116 and determines that the leading end of the medium has passed the position of the second media sensor 116 when the signal value of the second media signal changes from a value indicating the presence of a medium to a value indicating the absence of a medium. The acquisition unit 143 determines that the trailing end of the medium has passed the imaging position in the imaging device 117 when a first predetermined time has elapsed after the trailing end of the medium passes the position of the second media sensor 116. The first predetermined time is set to a time taken for a medium to move from the second media sensor 116 to the imaging position.

The acquisition unit 143 acquires the input image from the imaging device 117 every time the imaging device 117 generates a predetermined line of the input image and synthesizes the acquired input images when the imaging device 117 finishes imaging. The control unit 141 may collectively acquire input images for all lines at a time when the imaging device 117 finishes the imaging.

Subsequently, the identification unit 144 identifies a plurality of pieces of characteristic information in the input image (step S106).

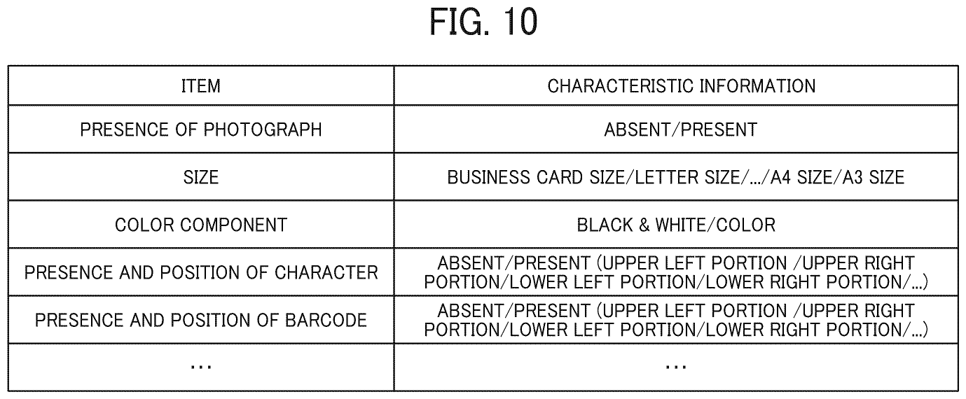

FIG. 10 is a table presenting the characteristic information.

As illustrated in FIG. 10, the characteristic information indicates characteristics of an input image regarding the imaging processing, the image processing or conveyance processing, particularly, characteristics of a conveyed medium included in the input image. Items in the characteristic information include, for example, the presence of a photograph, a size, a color component, the presence and/or the position of a character, the presence and/or the position of a barcode, and the degree of similarity between a medium currently conveyed and a medium previously conveyed. The characteristic information pieces relate to the setting items in the profile.

The presence of a photograph indicates whether a photograph is included in the input image and relates to, for example, the resolution, or color, compression ratio among the setting items in the profile. For example, the identification unit 144 determines whether a photograph is included in the input image using a discriminator trained in advance to output whether a photograph is included in an image when the image is input. The discriminator is trained in advance by, for example, deep learning using images including various photographs, and is stored in the first storage device 130 in advance. The identification unit 144 inputs the input image to the discriminator and determines whether a photograph is included in the input image on the basis of information output from the discriminator.

The identification unit 144 may estimate whether a photograph is included in the input image on the basis of the spatial frequency of the input image. In such a case, the identification unit 144 performs frequency conversion such as Fourier transform on the input image and identifies the distribution of spatial frequencies in the input image. When the maximum value of the spatial frequency in the input image is equal to or greater than a predetermined frequency threshold value, the identification unit 144 determines that a photograph is included in the input image. When the maximum value of the spatial frequency in the input image is less than the predetermined frequency threshold value, the identification unit 144 determines that the input image does not include a photograph. Alternatively or additionally, the identification unit 144 may estimate whether the input image includes a photograph on the basis of the distribution of gradation values such as brightness values or color values of pixels in the input image. In such a case, the identification unit 144 calculates the variance of the gradation values of the pixels in the input image. When the calculated variance is equal to or greater than a predetermined variance threshold value, the identification unit 144 determines that a photograph is included in the input image. When the calculated variance is less than the predetermined variance threshold value, the identification unit 144 determines that the input image does not include a photograph.

The size indicates the size of a medium included in the input image and relates to, for example, the media size among the setting items in the profile. For example, the identification unit 144 extracts edge pixels of which gradation values such as brightness values or color values differ from the gradation values of the adjacent pixels by equal to or greater than a predetermined threshold value in the input image. The identification unit 144 detects the largest area among areas surrounded by the edge pixels adjacent to each other as a medium area. The identification unit 144 identifies the size of the medium included in the input image on the basis of the number of pixels of the detected medium area and the resolution being set when the input image is generated.

The color component indicates a component such as color or black and white of a color included in the input image and relates to, for example, the color among the setting items in the profile. For example, the identification unit 144 determines whether the color component included in the input image is color or black and white on the basis of the distribution of the color values such as the R value, G value, or B value of each pixel in the input image. The identification unit 144 calculates the variances of the color values of the pixels in the input image. When the average value of the calculated variances is equal to or greater than a predetermined variance threshold value, the identification unit 144 determines that the component of the color included in the input image is color. When the average value of the calculated variances is less than the predetermined variance threshold value, the identification unit 144 determines that the component of the color included in the input image is black and white.

The presence and the position of a character indicates whether a character is included in the input image and the position of the character in the input image (when a character is included in the input image). The presence and the position of a character relates to, for example, the data extraction and the sorting among the setting items in the profile. For example, the identification unit 144 performs optical character recognition (OCR) processing on the input image and determines whether a character is included in the input image on the basis of whether a character is detected. Further, when a character is detected in the input image, the identification unit 144 identifies the position at which each character is detected in the input image as the position of each character in the input image.

The presence and the position of a barcode indicates whether a barcode is included in the input image and the position of the barcode in the input image (when a barcode is included in the input image). The presence and the position of a barcode relates to, for example, the data extraction and the sorting among the setting items in the profile. For example, the identification unit 144 determines whether a barcode is included in the input image using a discriminator trained in advance to output whether a barcode is included in an image and the position of the barcode when the image is input. The discriminator is trained in advance by, for example, deep learning using images including various barcodes, and is stored in the first storage device 130 in advance. The identification unit 144 inputs the input image to the discriminator, determines whether a barcode is included in the input image, and identifies the position of the barcode in the input image on the basis of information output from the discriminator.

The degree of similarity between a medium currently conveyed and a medium previously conveyed indicates the degree of similarity between a medium currently conveyed and a medium conveyed before the currently conveyed medium by a predetermined number of sheets, and relates to, for example, the sorting among the setting items in the profile. The predetermined number is set to the number of media to be collected into one group, which is set in the sorting in the profile. For example, the identification unit 144 calculates the degree of similarity between the input image currently acquired and an input image acquired before the input image currently acquired by the predetermined number of sheets as the degree of similarity between a medium included in the input image and a medium conveyed before the medium included in the input medium by the predetermined number of sheets. The degree of similarity is, for example, normalized cross-correlation.

Subsequently, the determination unit 145 identifies the setting value of each of the setting items included in the profile being set in step S102, that is, the profile being set when the input image is generated (step S107). The setting value of each of the setting items included in the profile being set is an example of information based on the setting value of each of a plurality of setting items included in the profile being set.

Subsequently, the determination unit 145 calculates the degree of matching between each of characteristic information pieces in the input image and the setting value of each of the setting items included in the profile being set when the input image is generated (step S108).

The determination unit 145 determines, for each of the setting items included in the profile, whether the characteristic information identified by the identification unit 144 and the setting value included in the profile being set by the setting unit 142 match each other.

Regarding the resolution, when it is identified as the characteristic information that a photograph is included in the input image, the determination unit 145 determines that the characteristic information and the setting value match each other when the setting value is equal to or greater than a resolution threshold value, and determines that the characteristic information and the setting value do not match each other when the setting value is less than the resolution threshold value. The resolution threshold value is set to a value (e.g., 200 dpi), which is a value between a resolution at which an image including a photograph is displayed suitable for viewing and a resolution at which an image including a photograph is displayed unsuitable for viewing. The resolution threshold value may be set to any desired value (e.g., 300 dpi). By contrast, when it is identified as the characteristic information that the input image does not include a photograph, the determination unit 145 determines that the characteristic information and the setting value match each other when the setting value is less than the resolution threshold value, and determines that the characteristic information and the setting value do not match each other when the setting value is equal to or greater than the resolution threshold value.

Regarding the media size, the determination unit 145 determines that the characteristic information and the setting value match each other when a difference between the size identified as the characteristic information and the setting value is equal to or less than a size threshold value, and determines that the characteristic information and the setting value do not match each other when the difference is greater than the size threshold value. The size threshold value is set in advance to any desired value (e.g., the difference between A3 size and A4 size). The size threshold value may be set to zero. In other words, the determination unit 145 may determine that the characteristic information and the setting value match each other when the size identified as the characteristic information and the setting value match each other, and may determine that the characteristic information and the setting value do not match each other when the size identified as the characteristic information and the setting value do not match each other. Further, the determination unit 145 may determine that the characteristic information and the setting value do not match each other when the setting value of the media size is set to automatic. Accordingly, the image reading apparatus 100 can determine that a profile in which the size of the conveyed medium is set is more appropriate than a profile in which the setting value of the media size is set to automatic.

Regarding the color, when it is identified as the characteristic information that a photograph is included in the input image as the characteristic information, the determination unit 145 determines that the characteristic information and the setting value match each other when the setting value is color, and determines that the characteristic information and the setting value do not match each other when the setting value is gray scale or binary. By contrast, when it is identified as the characteristic information that a photograph is included in the input image, the determination unit 145 determines that the characteristic information and the setting value match each other when the setting value is gray scale or binary, and determines that the characteristic information and the setting value do not match each other when the setting value is color.

Further, regarding the color, when the color component is identified as color as the characteristic information, the determination unit 145 determines that the characteristic information and the setting value match each other when the setting value is color, and determines that the characteristic information and the setting value do not match each other when the setting value is gray scale or binary. By contrast, when the color component is identified as black and white as the characteristic information, the determination unit 145 determines that the characteristic information and the setting value match each other when the setting value is gray scale or binary, and determines that the characteristic information and the setting value do not match each other when the setting value is color.

Regarding the compression ratio, when it is identified as the characteristic information that a photograph is included in the input image, the determination unit 145 determines that the characteristic information and the setting value match each other when the setting value is equal to or less than a compression ratio threshold value, and determines that the characteristic information and the setting value do not match each other when the setting value is greater than the compression ratio threshold value. The compression ratio threshold value is set to a value between a quantization value or a degree of compression at which an image including a photograph is decoded appropriately and a quantization value or a degree of compression at which an image including a photograph is decoded inappropriately. By contrast, when it is identified as the characteristic information that a photograph is included in the input image, the determination unit 145 determines that the characteristic information and the setting value match each other when the setting value is greater than the compression ratio threshold value, and determines that the characteristic information and the setting value do not match each other when the setting value is equal to or less than the compression ratio threshold value.

Regarding the data extraction, when a character is set as the type of data to be extracted as the setting value, the determination unit 145 determines that the characteristic information and the setting value match each other when it is identified as the characteristic information that a character is included in the input image and the position of the character matches a position being set as the setting value. By contrast, when a character is set as the type of data to be extracted as the setting value, the determination unit 145 determines that the characteristic information and the setting value do not match each other when it is identified as the characteristic information that a character is not included in the input image or when the position of a character identified as the characteristic information does not match a position being set as the setting value.

Regarding the data extraction, when a barcode is set as the type of data to be extracted as the setting value, the determination unit 145 determines that the characteristic information and the setting value match each other when it is identified as the characteristic information that a barcode is included in the input image and the position of the barcode matches a position being set as the setting value. By contrast, when a barcode is set as the type of data to be extracted as the setting value, the determination unit 145 determines that the characteristic information and the setting value do not match each other when it is identified as the characteristic information that a barcode is not included in the input image or when the position of a barcode identified as the characteristic information does not match a position being set as the setting value.

Regarding the sorting, when the number of media to be collected into one group is set as the setting value, the determination unit 145 determines whether a medium currently conveyed is the first medium of the group of media. When the media number of the currently conveyed is an addition value obtained by adding 1 to the multiple of the number of media to be collected into one group, the determination unit 145 determines that the medium currently conveyed is the first medium of the group of media. By contrast, when the medium number is not the addition value, the determination unit 145 determines that the medium currently conveyed is not the first medium of the group of media. When the medium currently conveyed is the first medium of the group of media, the determination unit 145 determines whether the degree of similarity identified as the characteristic information between the medium currently conveyed and a medium conveyed before the currently conveyed medium by the predetermined number of sheets is equal to or greater than a predetermined similarity threshold value. When the degree of similarity is equal to or greater than the similarity threshold value, the determination unit 145 determines that the conveyed medium is a separating sheet of a predetermined format and determines that the characteristic information and the setting value match each other. By contrast, when the degree of similarity is less than the similarity threshold value, the determination unit 145 determines that the conveyed medium is not a separating sheet of the predetermined format and determines that the characteristic information and the setting value do not match each other.

Further, regarding the sorting, the characteristic (e.g., the presence of the predetermined barcode or character) of a medium arranged at top of the media to bel collected into one group is set as the setting value, the determination unit 145 determines that the characteristic information and the setting value match each other when the media number of the medium currently conveyed is 1 and when it is identified as the characteristic information that the above characteristic is included in the input image.

The determination unit 145 determines that the characteristic information and the setting value do not match each other when the media number of the medium currently conveyed is 1 and when it is not identified as the characteristic information that the above characteristic is included in the input image.

The determination unit 145 calculates the degree of matching by, for example, by dividing the number of items for which it is determined that the characteristic information and the setting value match each other by the number of items for which determination has been performed as to whether the characteristic information and the setting value match each other. The determination unit 145 may set a weighted point for each of the setting items. In such a case, the determination unit 145 calculates the degree of matching by dividing the sum of points of the setting items for which it is determined that the characteristic information and the setting value match each other by the sum of points of the setting items for which determination has been performed as to whether the characteristic information and the setting value match each other. The determination unit 145 may calculate, for example, the number of items for which it is determined that the characteristic information and the setting value match each other or the reciprocal of the number of items for which it is determined that the characteristic information and the setting value do not match each other as the degree of matching.

Subsequently, the determination unit 145 determines whether the profile being set matches the characteristic of the input image (step S109). The determination unit 145 determines whether the profile being set matches the characteristic of the input image, for example, on the basis of whether the calculated degree of matching is equal to or greater than a threshold value. The threshold value is set by prior experiments to a value between the degree of matching of a case where the profile is considered to match the characteristic of the input image and the degree of matching of a case where the profile is considered not to match the characteristic of the input image. When the degree of matching is equal to or greater than the threshold value, the determination unit 145 determines that the profile being set matches the characteristic of the input image. When the degree of matching is less than the threshold value, the determination unit 145 determines that the profile being set does not match the characteristic of the input image. The image reading apparatus 100 can determine whether the profile matches the characteristic of the input image with high accuracy by using the degree of matching.

The determination unit 145 may determine that the profile matches the characteristic of the input image when the characteristic information and the setting value match each other in any one of the setting items, and may determine that the profile does not match the characteristic of the input image when the characteristic information and the setting value do not match each other in all of the setting items. Alternatively, the determination unit 145 may determine that the profile matches the characteristic of the input image when the characteristic information and the setting value match each other in all of the setting items, and may determine that the profile does not match the characteristic of the input image when the characteristic information and the setting value do not match each other in any one of the setting items.

As described above, the determination unit 145 compares the characteristic information pieces in the input image with the setting values themselves of the plurality of setting items included in the profile being set, thereby determining whether the profile matches the characteristic of the input image. Thus, the image reading apparatus 100 can determine whether the profile matches the characteristic of the input image with high accuracy.

When the determination unit 145 determines that the profile being set matches the characteristic of the input image (S109: YES), the operation proceeds to step S122.

By contrast, when the determination unit 145 determines that the profile being set does not match the characteristic of the input image (S109: NO), the third acquisition unit 146 acquires multiple profiles including a profile other than the profile being set (step S110). The third acquisition unit 146 acquires the profiles by receiving the profiles from the information processing apparatus 200 or a server via the first communication device 122. The profiles may be stored in the first storage device 130 in advance, and the third acquisition unit 146 may acquire the profiles by reading the profiles from the first storage device 130. The third acquisition unit 146 acquires all profiles other than the profile being among all types of profiles supported by the image reading apparatus 100. The third acquisition unit 146 may acquire all types of profiles supported by the image processing system 1, that is, all profiles other than the profile being among profiles supported by any image reading apparatus or software that the image processing system 1 includes. The software is, for example, driver software that causes the image reading apparatus 100 to execute each process.

Subsequently, the determination unit 145 identifies setting values of setting items included in the profiles acquired by the third acquisition unit 146, that is, the profiles other than the profile being set (step S111).

Subsequently, the determination unit 145 calculates the degrees of matching between the characteristic information pieces in the input image and the setting values of the setting items included in the profiles acquired by the third acquisition unit 146 in the same or substantially the same manner as described referring to step S108 (step S112).

Subsequently, the determination unit 145 determines whether the profile being set matches the characteristic of the input image (step S113). The determination unit 145 identifies the highest degree of matching among the degrees of matching between the characteristic information pieces in the input image and the setting values of the setting items included in the profiles acquired by the third acquisition unit 146. The determination unit 145 determines whether the profile being set matches the characteristic of the input image on the basis of whether the degree of matching calculated in step S108 is equal to or greater than the identified highest degree of matching. In other words, the determination unit 145 determines whether the profile being set matches the characteristic of the input image on the basis of whether the degree of matching of the profile being set is equal to or greater than the degrees of matching of the profiles other than the profile being set. When the degree of matching calculated in step S108 is equal to or greater than the identified highest degree of matching, the determination unit 145 determines that the profile being set matches the characteristic of the input image. By contrast, when the degree of matching calculated in step S108 is less than the identified highest degree of matching, the determination unit 145 determines that the profile being set does not match the characteristic of the input image.

As described above, the determination unit 145 determines whether the profile matches the characteristic of the input image on the basis of the result of comparison between the characteristic information pieces in the input image and the setting values of the plurality of setting items included in the profiles. The image reading apparatus 100 can determine whether the profile being set is appropriate with higher accuracy by determining whether the profile being set matches the characteristic of the input image than other profiles.

When the determination unit 145 determines that the profile being set matches the characteristic of the input image (S113: YES), the operation proceeds to step S122.

By contrast, when the determination unit 145 determines that the profile being set does not match the characteristic of the input image (S113: NO), the control unit 141 controls the motor 121 to stop driving. Accordingly, the control unit 141 controls the feed roller 112, the separation roller 113, the first conveyance roller 114, the second conveyance roller 115, the third conveyance roller 118, and/or the fourth conveyance roller 119 to stop rotating, and stops the conveyance of the subsequent media (step S114).

Thus, when the determination unit 145 determines that the profile being set does not match the characteristic of the input image, the control unit 141 stops the image generation process by the image reading apparatus 100 that has generated the input image. This prevents the image reading apparatus 100 from conveying a large number of media and imaging the conveyed media according to an inappropriate profile. Accordingly, the image reading apparatus 100 can reduce the occurrence of redo in the image reading process and enhance user convenience.

Subsequently, the control unit 141 identifies a profile of which the degree of matching between the setting values of the setting items in the profile and the characteristic information pieces in the input image is highest among the profiles acquired by the third acquisition unit 146. The control unit 141 determines whether the identified profile of which the degree of matching is highest is supported by the image reading apparatus 100 (step S115). When the identified profile is supported by the image reading apparatus 100, the control unit 141 does not perform any particular process, and the operation proceeds to step S117.

By contrast, when the identified profile is not supported by the image reading apparatus 100, the control unit 141 identifies another image reading apparatus or another software that supports the identified profile (step S116). Such another image reading apparatus is an image reading apparatus other than the image reading apparatus 100 and is included in the image processing system I to which the image reading apparatus 100 belongs. Such another software is software other than the software installed in the image reading apparatus 100 and is included in the image processing system 1.

Subsequently, the control unit 141 generates notification data for notifying a user that the profile being set does not match the characteristic of the input image. The control unit 141 notifies the user that the profile being set does not match the characteristic of the input image by displaying the generated notification data on the first display device 106 or by transmitting the generated notification data to the information processing apparatus 200 via the first communication device 122 (step S117). In response to receiving the notification data from the image reading apparatus 100 via the second communication device 203, the information processing apparatus 200 displays the received notification data on the second display device 202. The notification data is an example of information regarding a determination result by the determination unit 145.

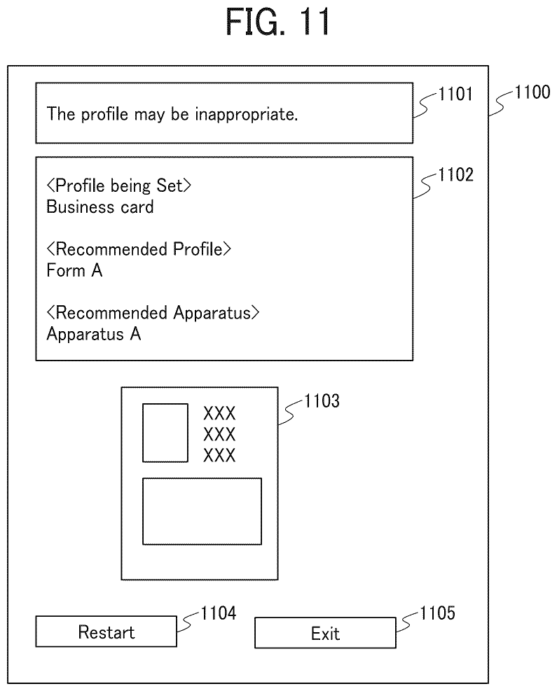

FIG. 11 is a schematic diagram illustrating an example of notification data 1100.

As illustrated in FIG. 11, the notification data 1100 includes summary information 1101, detailed information 1102, an image 1103, a restart button 1104, and an exit button 1105. The summary information 1101 indicates the determination result by the determination unit 145, that is, information indicating that the profile set by the user does not match the characteristic of the input image. The detailed information 1102 indicates, for example, a profile that is set by the user, a recommended profile that matches the characteristic of the input image, and a recommended device or recommended software that supports the recommended profile. The recommended profile is a profile of which the degree of matching is highest, which is identified in step S113. The recommended device or the recommended software is the image reading apparatus or the software identified in step S116.

As described above, when the determination unit 145 determines that the profile being set does not match the characteristic of the input image, the control unit 141 notifies the user of information regarding the determination result by the determination unit 145. This allows the user to consider whether the profile being set is appropriate, and when the profile being set is not appropriate, change the profile. The user can have the image reading apparatus 100 to restart the conveying and imaging of media according to the changed profile. Accordingly, the user can appropriately deal with a medium included in the input image, and the image reading apparatus 100 can enhance user convenience.

Further, the control unit 141 notifies the user of information regarding a profile that most matches the characteristic information pieces in the input image among multiple profiles as a profile that matches the input image (medium). Accordingly, the user can recognize an appropriate profile for the input image (medium). The user can have the image reading apparatus 100 to restart the conveying and imaging of media according to such an appropriate profile. Thus, the image reading apparatus 100 can enhance user convenience.

Furthermore, the control unit 141 notifies the user of information regarding an image reading apparatus or software that supports a profile matching the input image (medium) determined not to match the profile being set among other image reading apparatuses or other software. This allows the user to recognize an image reading apparatus or software that can generate an image suitable for a conveyed medium and acquire a desired image using the image reading apparatus or software. Thus, the image reading apparatus 100 can enhance user convenience.

The image 1103 is an input image obtained by imaging a conveyed medium or a processed image based on the input image. By viewing the image 1103, the user can confirm the image of the conveyed medium captured or processed according to the profile being set, and can confirm the appropriateness of the profile being set. The restart button 1104 is a button for restarting conveying media. By pressing the restart button 1104 after taking out the conveyed medium, the user can restart conveying and imaging the remaining media according to a profile that is currently set. In other words, when the profile being set is correct, the user can designate that the profile being set is correct by pressing the restart button 1104. The exit button 1105 is a button for ending the image reading process. By pressing the exit button 1105, the user can cancel the conveying and imaging of the remaining media according to the profile that is currently set. In other words, when the profile being set is not correct, the user can designate that the profile being set is not correct by pressing the exit button 1105.

Subsequently, the control unit 141 waits until an instruction to restart or finish the conveying and imaging of the medium is input by the user using the first input device 105 or the information processing apparatus 200 and an instruction signal is received from the first input device 105 or the first communication device 122 (step S118). When the restart button 1104 is pressed by the user, the control unit 141 receives the instruction signal from the first input device 105 or the first communication device 122 that instructs to restart the conveying and imaging the media. By contrast, when the exit button 1105 is pressed by the user, the control unit 141 receives the instruction signal from the first input device 105 or the first communication device 122 that instructs to finish the conveying and imaging of the media.

In response to receiving the instruction signal, the control unit 141 determines whether the profile being set is correct by determining whether the instruction signal instructs to restart the conveying and imaging of the media or the instruction signal instructs to finish the conveying and imaging of the media (step S119). When the instruction signal instructs to restart the conveying and imaging of the media, the user designate that the profile being set is correct. By contrast, when the instruction signal instructs to finish the conveying and imaging of the media, the user designate that the profile being set is not correct. As described above, the control unit 141 notifies the user of information regarding the determination result by the determination unit 145, and then receives the designation from the user as to whether the profile being set is correct. When the instruction signal instructs to finish the conveying and imaging of the media, that is, when the user designates that the profile being set is not correct (S119: NO), the control unit 141 finishes the image reading process without conveying the remaining media according to the profile being set.

By contrast, when the instruction signal instructs to restart the conveying and imaging of the media, that is, when the user designates that the profile being set is correct (S119: YES), the determination unit 145 changes a determination criterion for determining whether the profile matches the characteristic of the input image (step S120). The determination unit 145 reduces the weight for subsequent determinations of the setting item for which it has been determined that the characteristic information in the input image and the information regarding the setting value included in the profile being set do not match each other among the setting items.

For example, the determination unit 145 reduces the point (the size of the weighted point) for calculating the degree of matching for the setting item for which it has been determined that the characteristic information in the input image and the information regarding the setting value included in the profile being set do not match each other. In future determinations as to whether the profile matches the characteristic of the input image, the determination unit 145 may exclude the setting item for which it has been determined that the characteristic information in the input image does not match the information regarding the setting value included in the profile being set from targets for the determination. This prevents the image reading apparatus 100 from erroneously determining that the profile designated as being correct by the user is inappropriate for the same reason in future determinations. Accordingly, the image reading apparatus 100 can prevent the user from being erroneously notified of the information regarding the determination result or the image generation process from being erroneously stopped. Thus, the image reading apparatus 100 can prevent the user from being bothered.

Subsequently, the control unit 141 re-drives the motor 121 to re-rotate the feed roller 112, the separation roller 113, the first conveyance roller 114, the second conveyance roller 115, the third conveyance roller 118, and/or the fourth conveyance roller 119. Thus, the control unit 141 feeds and conveys remaining media from the feed table 103 (step S121).

Subsequently, the control unit 141 generates a processed image on the basis of the input image, and outputs the processed image by transmitting the processed image to the information processing apparatus 200 via the first communication device 122 (step S122). The control unit 141 generates the processed image by performing image processing on the input image according to the profile acquired in step S102. When no image processing needs to be performed, the control unit 141 uses the input image itself as the processed image.

Subsequently, the control unit 141 determines whether a medium remains on the feed table 103 on the basis of the first media signal received from the first media sensor 111 (step S123). When a medium remains on the feed table 103, the control unit 141 increments the media number of the medium to be conveyed by one and sets the media number of the media to be conveyed next. Subsequently, the control unit 141 returns the operation to step S105 and repeats the processes of steps S105 to step S123.

By contrast, when no media remains on the feed table 103, the control unit 141 stops the motor 121 to stop the feed roller 112, the separation roller 113, the first conveyance roller 114, the second conveyance roller 115, the third conveyance roller 118, and the fourth conveyance roller 119 (step S124). Thus, the control unit 141 stops conveying the media. Then, the control unit 141 ends the image reading process.

The processes of steps S107 to S109, the processes of steps S110 to S113, the processes of steps S114 and S121, the processes of steps S115 to S116, the process of step S117, the processes of steps S118 to S119, and/or the process of step S120 may be omitted. When the processes of steps S107 to S109 are omitted, the processes of steps S110 to S113 are also omitted.

As described above in detail, the image reading apparatus 100 determines whether the profile that is set by the user matches the characteristic information of the input image by comparing the setting value of each of the setting items included in the profile with the characteristic information in the input image. When the profile does not match the characteristic of the input image, the image reading apparatus 100 notifies the user that the profile does not match the characteristic of the input image and stops the image generation process. The image reading apparatus 100 can determine whether the profile matches the characteristic of the input image with high accuracy by using the combination of the plurality of setting items. Thus, the image reading apparatus 100 performs the notification to the user or the stop of the image generation process when the profile is not appropriate, and further prevents the notification to the user or the stop of the image generation process from being erroneously performed when the profile is appropriate. Thus, the image reading apparatus 100 can enhance user convenience.

When the user erroneously sets an inappropriate profile, an image obtained by imaging a medium according to the inappropriate profile may be generated, and an inappropriate image may be generated. A bundle of media of mixed media types may be conveyed collectively. For example, a photograph is mixed in a bundle of forms. In this case, an image may be generated by imaging a certain type of medium according to a profile suitable for a particular type of medium, which is different from the certain type of medium. This may lead to generation of an inappropriate image. When the profile does not match the characteristic of the input image, the image reading apparatus 100 notifies the user that the profile does not match the characteristic of the input image and stops the image generation process. Accordingly, the user can have the image reading apparatus 100 to restart the conveying and imaging of the medium according to appropriate settings. As a result, the image reading apparatus 100 can prevent the occurrence of redo in the image reading process due to the generation of an image according to incorrect settings. This enhances user convenience.

Further, even when the user has low knowledge or skill relating to the image reading processing, the user can appropriately select profile, another image reading apparatus, or another software that can generate a desired image. This allows the image reading apparatus 100 to prevent the occurrence of redo in the image reading process due to the use of inappropriate settings, image reading apparatus 100, or software, thereby reducing the decrease in the work efficiency or the work quality of the user.

Further, the image reading apparatus 100 can collectively set multiple setting items regarding imaging processing, image processing, or conveyance processing by using the profile. This enhances the work efficiency of the user.

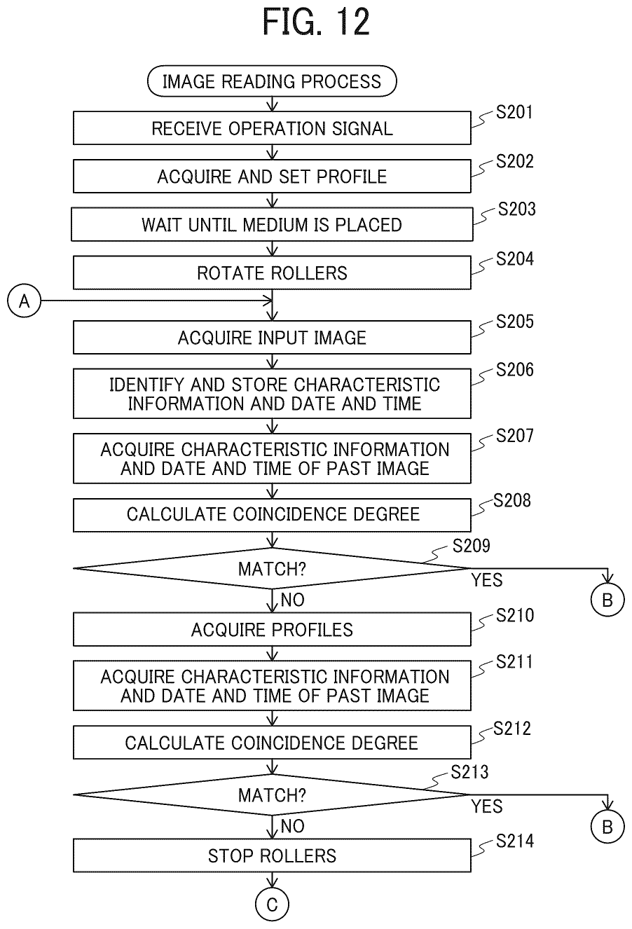

FIG. 12 is a flowchart illustrating an example of a part of the operation of the image reading process performed by the image reading apparatus 100, according to another embodiment.

The operation of flowchart in FIG. 12 is executed instead of the operation of flowchart illustrated in FIG. 8. Since the processes of steps S201 to S205 and S214 of FIG. 12 are respectively the same or substantially the same as the processes of steps S101 to S105 and S114 of FIG. 8, redundant descriptions thereof will be omitted. A description is given below of steps S206 to S213.

After the acquisition unit 143 acquires the input image in step S205, the identification unit 144 identifies a plurality of pieces of characteristic information in the input image, identifies the date and time when the input image is generated, and stores the identified characteristic information pieces and the identified date and time in a history table in the first storage device 130 (step S206).

The identification unit 144 identifies the characteristic information in the same or substantially the same manner as described referring to step S106. As in the case where the operation of the flowchart illustrated in FIG. 8 is executed, items in the characteristic information include, for example, the presence a photograph, a size, a color component, the presence and/or the position of a character, and the presence and/or the position of a barcode. In the present embodiment, the items in the characteristic information may include, for example, a medium background color and a character color, instead of or in addition to the color component.

The medium background color is a ground color of a medium included in the input image, and is information regarding, for example, the color among the setting items in the profile. For example, the identification unit 144 detects a medium area in the same or substantially the manner as in the case of identifying the size of the medium. The identification unit 144 determines which of multiple predetermined color ranges (e.g., a white color range, a black color range, a red color range, a green color range, and a blue color range) the color values (e.g., an R value, a G value, an a B value) of the pixels in the medium area belong to respectively. The identification unit 144 identifies a color corresponding to a particular color range having the largest number of pixels to which the color values belong as the background color of the medium included in the input image.

The character color is a color of a character included in the input image, and is information regarding, for example, the color among the setting items in the profile. For example, the identification unit 144 detects a medium area in the same or substantially the manner as in the case of identifying the size of the medium. The identification unit 144 performs OCR processing on the medium area and identifies a character area in which a character is detected in the input image. The identification unit 144 determines which of multiple predetermined color ranges (e.g., a white color range, a black color range, a red color range, a green color range, and a blue color range) the color values (e.g., an R value, a G value, an a B value) of the pixels in the character area belong to respectively. The identification unit 144 identifies a color corresponding to a particular color range having the largest number of pixels to which the color values belong as the color of character included in the input image, except for the color range identified as the medium background color.

In the present embodiment, the items in the characteristic information may further include, for example, a resolution, a file format such as a portable document format (PDF) or JPEG, a print side (front side/back side), the number of pages, the presence of ruled lines, the presence of a seal, and the language of a character. These information pieces are included in the profile, and the identification unit 144 identifies each information pieces on the basis of the profile being set when the input images (past images) were generated. The identification unit 144 may identify, for example, the presence of ruled lines, the presence of a seal, and the language of a character by using a known image processing technology.

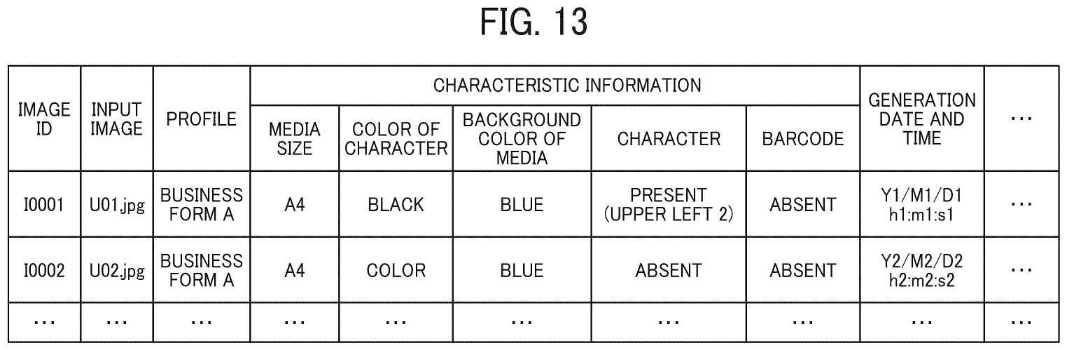

FIG. 13 is a schematic diagram for describing a data structure of the history table.

As illustrated in FIG. 13, the history table stores, for each of media conveyed by the image reading apparatus 100, an image identifier (ID), an input image, a profile, characteristic information, and a generation date and time in association with each other. The image ID is information for identifying the generated input image. The profile is the profile that was set when the associated input image was generated. The characteristic information is the characteristic information identified on the basis of the associated input image. The generation date and time is the date and time when the associated input image was generated.

The identification unit 144 assigns a new image ID to the generated input image, and stores the assigned image ID in association with the generated input image, the profile being set, the identified characteristic information, and the identified generation date and time in the history table.

Subsequently, the second acquisition unit 147 acquires a plurality of pieces of characteristic information in one or more past images generated in the past according to the profile being set and the date and time when each of the past images was generated (step S207).

The second acquisition unit 147 refers to the history table and identifies a specific number of input images generated in the past according to the profile being set as the past images. For example, the second acquisition unit 147 identifies a predetermined number of latest input images generated according to the profile being set as the past images. The predetermined number is set to one or more desired numbers. The second acquisition unit 147 may identify one or more input image generated in the latest predetermined period according to the profile being set as the past images. Alternatively, the second acquisition unit 147 may identify all input images generated according to the profile being set as the past images. The second acquisition unit 147 acquires characteristic information pieces and the generation dates and times identified on the basis of the past images as the characteristic information pieces in the past images and the dates and times when the past images were generated. The characteristic information pieces in the past images are an example of information based on the setting value of each of a plurality of setting items included in the profile being set.

Subsequently, the determination unit 145 calculates the degree of coincidence between the characteristic information pieces in the input image and the characteristic information pieces in each of the past images and the degree of coincidence between the generation date and time when the input image was generated and the generation dates and times when the past images were generated (step S208). In the following description, the degree of coincidence between the characteristic information pieces in the input image and the characteristic information pieces in each of the past images may be referred to as a first degree of coincidence. Further, the degree of coincidence between the generation date and time when the input image was generated and the generation dates and times when the past images were generated may be referred to as a second degree of coincidence.

The determination unit 145 refers to the history table, aggregates the setting values of the characteristic information pieces identified on the basis of the past images for each of the items in the characteristic information, and calculates the ratio of the number of past images having each setting value to the total number of past images for each of the setting values. Further, the determination unit 145 calculates, for each of multiple predetermined date and time ranges, the ratio of the number of past images generated in each of the date and time ranges to the total number of past images. The date and time range is set to any range such as a time zone (0:00 to 1:00, 1:00 to 2:00, etc.), a day of the week (Sunday, Monday, etc.), a week (first week, second week, etc.), a month (January, February, etc.), or a year (2000, 2001, etc.). The determination unit 145 stores the ratio for each of the items in the characteristic information, which is identified for each of the profiles, in a tabulation table.

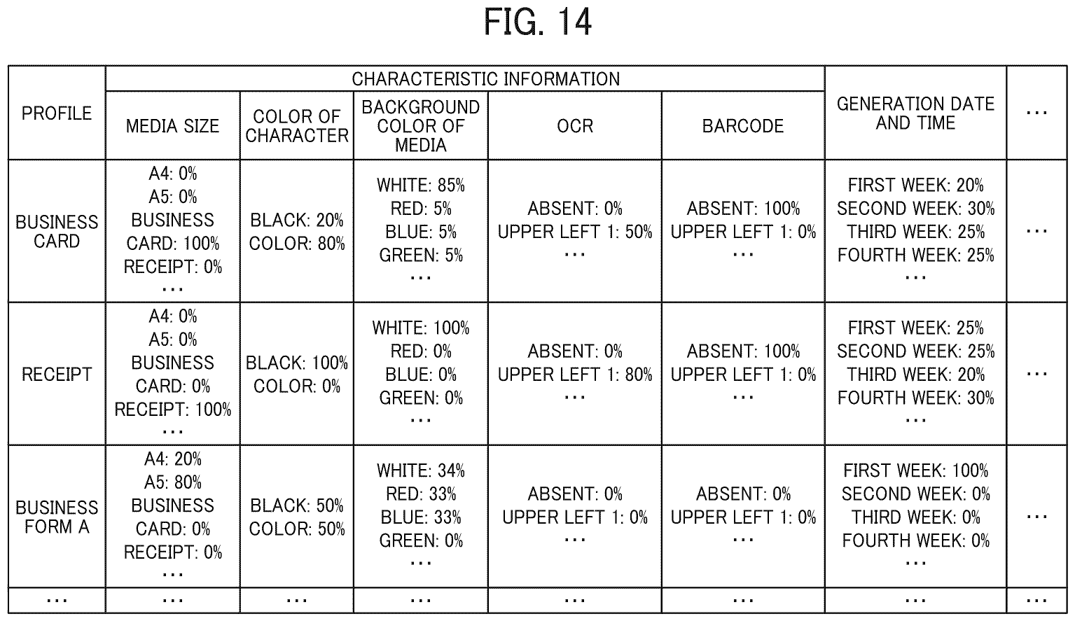

FIG. 14 is a schematic diagram for describing a data structure of the tabulation table.

As illustrated in FIG. 14, in the tabulation table, the ratio of each of the setting values in the items in the characteristic information and the ratio of each of the date and time ranges are stored in association with each other for each of the profiles.

The determination unit 145 refers to the tabulation table and identifies the ratios of the past images having the setting values of the characteristic information identified on the basis of the input image currently generated for each of the items in the characteristic information for the profile being set. The determination unit 145 calculates, for example, an average value or a total value of the ratios identified for the items in the characteristic information as the first degree of coincidence. The determination unit 145 may calculate a weighted average value or a weighted total obtained by weighting the ratios for the items as the first degree of coincidence. Alternatively, the determination unit 145 may calculate a division value obtained by dividing the number of items having a ratio equal to or greater than a predetermined ratio threshold value by the total number of items for which the ratio has been calculated as the first degree of coincidence. Still alternatively, the determination unit 145 may calculate, for example, the number of items having a ratio equal to or greater than the ratio threshold value or the reciprocal of the number of items having a ratio less than the ratio threshold value as the first degree of coincidence.

Further, the determination unit 145 refers to the tabulation table and calculates the ratio of the past images generated in a time period including the generation date and time of the input image currently generated as the second degree of coincidence for the profile being set.

Subsequently, the determination unit 145 determines whether the profile being set matches the characteristic of the input image (step S209).

The determination unit 145 determines whether the profile being set matches the characteristic of the input image, for example, on the basis of whether the first degree of coincidence is equal to or greater than a first threshold value. The first threshold value is set by prior experiments to a value between the first degree of coincidence of a case where the profile is considered to match the characteristic of the input image and the first degree of coincidence of a case where the profile is considered not to match the characteristic of the input image. When the first degree of coincidence is equal to or greater than the first threshold value, the determination unit 145 determines that the profile being set matches the characteristic of the input image. When the first degree of coincidence is less than the first threshold value, the determination unit 145 determines that the profile being set does not match the characteristic of the input image. The image reading apparatus 100 can determine whether the profile matches the characteristic of the input image with high accuracy by using the degree of coincidence between the characteristic information pieces in the input image and the characteristic information pieces in the past images.

Alternatively, the determination unit 145 may determine that the profile matches the characteristic of the input image when the characteristic information of any one of the items in the input image matches the characteristic information of the any one of the items in the past images. Further, the determination unit 145 may determine that the profile does not match the characteristic of the input image when the characteristic information of all of the items in the input image does not match the characteristic information of all of the items in the past images. In such a case, the determination unit 145 identifies, as the first degree of coincidence, the largest value among the ratios of the past images having the setting values of the characteristic information identified on the basis of the input image currently generated in the items in the characteristic information. Alternatively, the determination unit 145 may determine that the profile matches the characteristic of the input image when the characteristic information of all of the items in the input image matches the characteristic information of all of the items in the past images. Further, the determination unit 145 may determine that the profile does not match the characteristic of the input image when the characteristic information of any one of the items in the input image does not match the characteristic information of the any one of the items in the past images. In such a case, the determination unit 145 identifies, as the first degree of coincidence, the smallest value among the ratios of the past images having the setting values of the characteristic information identified on the basis of the input image currently generated in the items in the characteristic information.

Still alternatively, the determination unit 145 may determine whether the profile matches the characteristic of the input image on the basis of the characteristic information of only any one of the items. In such a case, the determination unit 145 identifies, as the first degree of coincidence, the ratio of the past image having the setting value of the characteristic information identified on the basis of the input image currently generated in a predetermined one item among the items in the characteristic information.

As described above, the determination unit 145 determines whether the profile being set matches the characteristic of the input image by comparing the characteristic information pieces in the input image with the characteristic information pieces in the past image. The image reading apparatus 100 typically processes various types of media for users. The media processed according to the same profile are likely to be the same type of media. The image reading apparatus 100 can determine whether the profile being set is appropriate with high accuracy by comparing the characteristic information in the input image with the characteristic information in the past image generated in the past according to the profile being set.

In particular, the determination unit 145 determines whether the profile being set matches the characteristic of the input image by comparing the characteristic information pieces in the input image with the characteristic information pieces in the past images. Accordingly, the image reading apparatus 100 can determine whether the profile being set is appropriate with higher accuracy on the basis of the tendency of the past images generated in the past according to the profile being set.

The determination unit 145 may determine whether the profile being set matches the characteristic of the input image on the basis of whether the second degree of coincidence is equal to or greater than a second threshold value. The second threshold value is set by prior experiments to a value between the second degree of coincidence of a case where the profile is considered to match the characteristic of the input image and the second degree of coincidence of a case where the profile is considered not to match the characteristic of the input image. When the second degree of coincidence is equal to or greater than the second threshold value, the determination unit 145 determines that the profile being set matches the characteristic of the input image. When the second degree of coincidence is less than the second threshold value, the determination unit 145 determines that the profile being set does not match the characteristic of the input image. The image reading apparatus 100 can determine whether the profile matches the characteristic of the input image with high accuracy by using the degree of coincidence between the generation date and time of the input image and the generation dates and times of the past images.

The determination unit 145 may determine whether the profile being set matches the characteristic of the input image on the basis of both the first degree of coincidence and the second degree of coincidence. When the first degree of coincidence is equal to or greater than the first threshold value and the second degree of coincidence is also equal to or greater than the second threshold value, the determination unit 145 determines that the profile being set matches the characteristic of the input image. By contrast, when the first degree of coincidence is less than the first threshold value or the second degree of coincidence is less than the second threshold value, the determination unit 145 determines that the profile being set does not match the characteristic of the input image. Alternatively, when the first degree of coincidence is equal to or greater than the first threshold value or when the second degree of coincidence is equal to or greater than the second threshold value, the determination unit 145 determines that the profile being set matches the characteristic of the input image. By contrast, when the first degree of coincidence is less than the first threshold value and the second degree of coincidence is also less than the second threshold value, the determination unit 145 determines that the profile being set does not match the characteristic of the input image.

Alternatively, the determination unit 145 calculates an average value, a total value, a weighted average value, or a weighted sum of the first degree of coincidence and the second degree of coincidence as a third degree of coincidence. When the third degree of coincidence is equal to or greater than a third threshold value, the determination unit 145 determines that the profile being set matches the characteristic of the input image. When the third degree of coincidence is less than the third threshold value, the determination unit 145 determines that the profile being set does not match the characteristic of the input image. The third threshold value is set to, for example, an average value, a total value, a weighted average value, or a weighted sum of the first threshold value and the second threshold value.

As described above, the determination unit 145 determines whether the profile being set matches the characteristic of the input image further on the basis of the result of comparison between the generation date and time when the input image was generated and the generation dates and times when the past images were generated. For example, handouts of the same type distributed in, for example, schools, cram schools, or kindergartens are likely to be distributed in the same time period and is likely to be scanned by users in the same time period. Accordingly, the image reading apparatus 100 can determine whether the profile being set is appropriate with higher accuracy by comparing the generation date and time when the input image was generated with the generation dates and times when the past images were generated.

Further, as described above, the second acquisition unit 147 identifies the predetermined number of latest input images generated according to the profile being set as the past images. For example, handouts distributed in, for example, schools, cram schools, or kindergartens may have different characteristics (e.g., a medium background color) depending on the time of year (e.g., the first semester or the second semester). Further, such handouts may be distributed and scanned at different time periods (e.g., the first week or the second week). By using the latest input images as the past images, the determination unit 145 can flexibly respond to changes in the characteristic of the handouts or the distribution period and can determine whether the profile being set is appropriate with high accuracy.

When the determination unit 145 determines that the profile being set matches the characteristic of the input image, the operation proceeds to step S122.

By contrast, when the determination unit 145 determines that the profile being set does not match the characteristic of the input image, the third acquisition unit 146 acquires multiple profiles including a profile other than the profile being set in the same or substantially the same manner as step S110 (step S210).

Subsequently, the determination unit 145 acquires characteristic information pieces in past images generated in the past according to the profiles acquired by the third acquisition unit 146, that is, the profiles other than the profile being set, and the dates and times when the past images were generated (step S211). The determination unit 145 refers to the history table and identifies a specific number of input images generated in the past according to the profiles acquired by the third acquisition unit 146 as the past images in the same or substantially the same manner as described referring to step S207. The determination unit 145 acquires characteristic information pieces and generation dates and times identified on the basis of the past image as characteristic information pieces in the past images and dates and times when the past images were generated.

Subsequently, the determination unit 145 calculates the first degrees of coincidence between the characteristic information pieces in the input image and the characteristic information pieces in the past images generated according to the profiles acquired by the third acquisition unit 146. Further, the determination unit 145 calculates the second degrees of coincidence between the generation date and time when the input image was generated and the generation dates and times when the past images generated according to the profiles acquired by the third acquisition unit 146 were generated (step S212). The determination unit 145 calculates the first degree of coincidence and the second degree of coincidence in the same or substantially the same manner as described referring to step S208.

Subsequently, the determination unit 145 determines whether the profile being set matches the characteristic of the input image (step S213). The determination unit 145 identifies the highest first degree of coincidence among the first degrees of coincidence between the characteristic information pieces in the input image and the characteristic information pieces in the past images generated according to the profiles acquired by the third acquisition unit 146. The determination unit 145 determines whether the profile being set matches the characteristic of the input image on the basis of whether the first degree of coincidence calculated in step S208 is equal to or greater than the identified highest first degree of coincidence. In other words, the determination unit 145 determines whether the profile being set matches the characteristic of the input image on the basis of whether the first degree of coincidence of the profile being set is equal to or greater than the first degrees of coincidence of the profiles other than the profile being set. When the first degree of coincidence calculated in step S208 is equal to or greater than the identified highest first degree of coincidence, the determination unit 145 determines that the profile being set matches the characteristic of the input image. By contrast, when the first degree of coincidence calculated in step S208 is less than the identified highest first degree of coincidence, the determination unit 145 determines that the profile being set does not match the characteristic of the input image.

The determination unit 145 may determine whether the profile being set matches the characteristic of the input image on the basis of the second degree of coincidence. In such a case, the determination unit 145 identifies the highest second degree of coincidence among the second degrees of coincidence between the generation date and time when the input image was generated and the generation dates and times when the past images generated according to the profiles acquired by the third acquisition unit 146 were generated. The determination unit 145 determines whether the profile being set matches the characteristic of the input image on the basis of whether the second degree of coincidence calculated in step S208 is equal to or greater than the identified highest second degree of coincidence.

The determination unit 145 may determine whether the profile being set matches the characteristic of the input image on the basis of the third degree of coincidence, which is an average value, a total value, a weighted average value, or a weighted sum of the first degree of coincidence and the second degree of coincidence. In such a case, the determination unit 145 identifies the highest third degree of coincidence among the third degrees of coincidence between the input image and the past images generated according to the profiles acquired by the third acquisition unit 146. The determination unit 145 determines whether the profile being set matches the characteristic of the input image on the basis of whether the third degree of coincidence calculated in step S208 is equal to or greater than the identified highest third degree of coincidence.

As described above, the determination unit 145 determines whether the profile being set matches the characteristic of the input image further on the basis of the result of comparing the characteristic information pieces in the input image with the characteristic information pieces in the past images generated according to multiple profiles. Further, the determination unit 145 determines whether the profile being set matches the characteristic of the input image further on the basis of the result of comparing the generation date and time of the input image and the generation dates and times of the past images generated according to multiple profiles. The image reading apparatus 100 can determine whether the profile being set is appropriate with higher accuracy by determining whether the profile being set matches the characteristic of the input image than other profiles.

When the determination unit 145 determines that the profile being set matches the characteristic of the input image, the operation proceeds to step S122. When the determination unit 145 determines that the profile being set does not match the characteristic of the input image, the operation proceeds to step S214.

In the present embodiment, the notification data 1100 in FIG. 11 displays, as the recommended profile, the profile of which the first degree of coincidence is highest, the profile of which the second degree of coincidence is highest, or the profile of which the third degree of coincidence is highest, which is identified in step S213. In other words, the control unit 141 notifies the user of information regarding a profile that is most suitable for the characteristic information pieces in the input image among multiple profiles as a profile suitable for the input image (medium). Accordingly, the user can recognize an appropriate profile for the input image (medium). The conveyance and imaging of media are restarted according to such an appropriate profile. Thus, the image reading apparatus 100 can enhance user convenience.

In the present embodiment, the processes of steps S207 to S209, the processes of steps S210 to S213, the processes of steps S214 and S121, the processes of steps S115 to S116, the process of step S117, the processes of steps S118 to S119, and/or the process of step S120 may be omitted. When the processes of steps S207 to S209 are omitted, the processes of steps S210 to S213 are also omitted. In step S208, the determination unit 145 may generate the history table each time a predetermined number (e.g., 10) of input images are generated, instead of generating the history table each time an input image is generated. Thus, the determination unit 145 can reduce the processing load of the image reading process.

As described above in detail, the image reading apparatus 100 determines whether the profile that is set by a user matches the characteristic of the input image by comparing the characteristic information pieces in the past images that is generated in the past according to the profile being set with the characteristic information pieces in the input image. Also in this case, the image reading apparatus 100 can determine whether the profile matches the characteristic of the input image with high accuracy by using the combination of the plurality of items. Thus, the image reading apparatus 100 performs the notification to the user or the stop of the image generation process when the profile is not appropriate, and further prevents the notification to the user or the stop of the image generation process from being erroneously performed when the profile is appropriate. Thus, the image reading apparatus 100 can enhance user convenience.

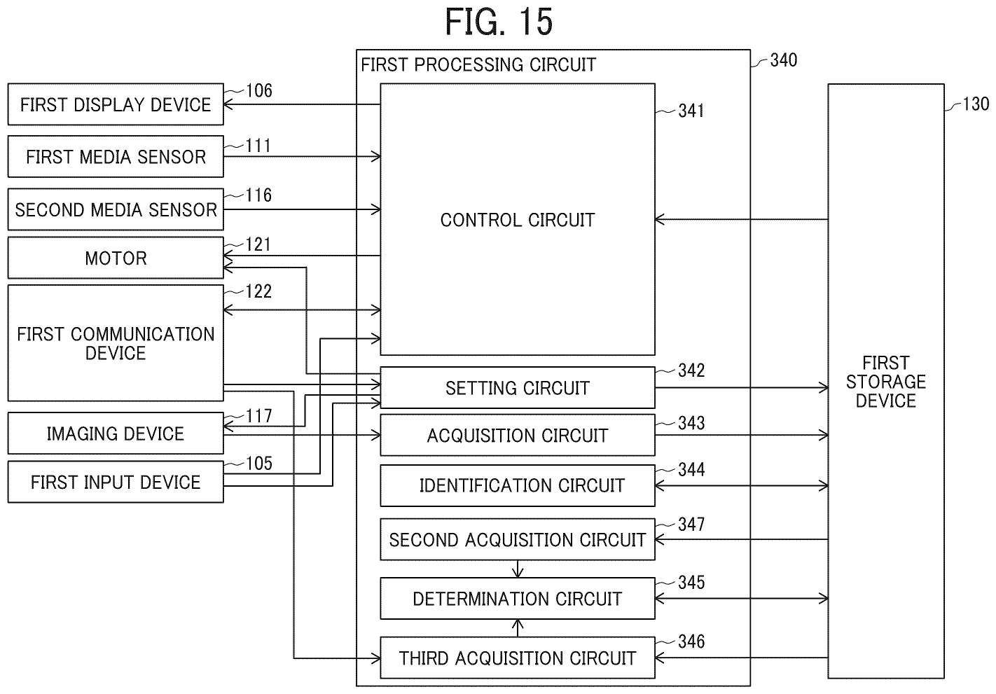

FIG. 15 is a block diagram schematically illustrating a configuration of a first processing circuit 340 in an image reading apparatus according to another embodiment.

The first processing circuit 340 is used instead of the first processing circuit 140 and performs, for example, an image reading process. The first processing circuit 340 includes a control circuit 341, a setting circuit 342, an acquisition circuit 343, an identification circuit 344, a determination circuit 345, a third acquisition circuit 346, and a second acquisition circuit 347.

The control circuit 341 is an example of a control unit and functions in the same or substantially the same manner as the control unit 141. The control circuit 341 receives the operation signal from the first input device 105 or the first communication device 122, the first media signal from the first media sensor 111, and the second media signal from the second media sensor 116. Further, the control circuit 341 reads out a determination result indicating whether the profile being set matches the characteristic of the input image from the first storage device 130. The control circuit 341 controls the motor 121 on the basis of the information received or read, and outputs information regarding the determination result to the first display device 106 or the first communication device 122. The control circuit 341 reads out the input image from first storage device 130, generates a processed image on the basis of the input image, and outputs the processed image to first display device 106 or first communication device 122.

The setting circuit 342 is an example of a setting unit and functions in the same or substantially the same manner as the setting unit 142. The setting circuit 342 receives the profile from the first input device 105 or the first communication device 122, sets the received profile in the first storage device 130, and sets the imaging device 117 or the motor 121.

The acquisition circuit 343 is an example of an acquisition unit and functions in the same or substantially the same manner as the acquisition unit 143. The acquisition circuit 343 acquires the input image from the imaging device 117 and stores the acquired input image in the first storage device 130.

The identification circuit 344 is an example of an identification unit and functions in the same or substantially the same manner as the identification unit 144. The identification circuit 344 reads out the input image from the first storage device 130, identifies characteristic information regarding the setting items in the input image, and stores the identified characteristic information in the first storage device 130.

The determination circuit 345 is an example of a determination unit and functions in the same or substantially the same manner as the determination unit 145. The determination circuit 345 reads out the characteristic information in the input image and the setting values of the setting items included in the profile from the first storage device 130. Further, the determination circuit 345 receives characteristic information pieces in the past images that were generated in the past according the profile being set from the second acquisition circuit 347. The determination circuit 345 receives multiple profiles from the third acquisition circuit 346. The determination circuit 345 determines whether the profile matches the characteristic of the input image on the basis of the information being read or received, and stores the determination result in the first storage device 130.

The third acquisition circuit 346 is an example of a third acquisition unit and functions in the same or substantially the same manner as the third acquisition unit 146. The third acquisition circuit 346 receives the profiles from the first communication device 122 or reads out the profiles from the first storage device 130, and outputs the profiles to the determination circuit 345.

The second acquisition circuit 347 is an example of a second acquisition unit and functions in the same or substantially the same manner as the second acquisition unit 147. The second acquisition circuit 347 reads out the characteristic information pieces in the past images that were generated in the past according the profile being set from the first storage device 130, and outputs the characteristic information pieces to the determination circuit 345.

As described above in detail, the image reading apparatus using the first processing circuit 340 also enhances user convenience.

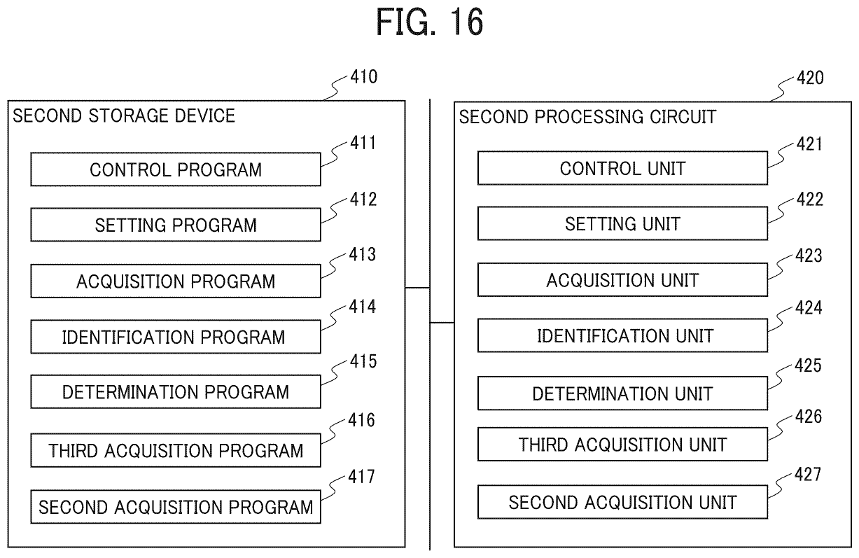

FIG. 16 is a diagram schematically illustrating configurations of a second storage device 410 and a second processing circuit 420 in an information processing apparatus according to still another embodiment.

As illustrated in FIG. 16, the second storage device 410 stores a control program 411, a setting program 412, an acquisition program 413, an identification program 414, a determination program 415, a third acquisition program 416, and a second acquisition program 417. These programs are functional modules implemented by software operating on a processor. The second processing circuit 420 reads the programs stored in the first storage device 130 and operates according to the read programs, thereby functioning as a control unit 421, a setting unit 422, an acquisition unit 423, an identification unit 424, a determination unit 425, a third acquisition unit 426, and a second acquisition unit 427.

The control unit 421, the setting unit 422, the acquisition unit 423, the identification unit 424, the determination unit 425, the third acquisition unit 426, and the second acquisition unit 427 have the same functions as the control unit 141, the setting unit 142, the acquisition unit 143, the identification unit 144, the determination unit 145, the third acquisition unit 146, and the second acquisition unit 147 of the image reading apparatus 100, respectively. The second storage device 410 stores the data stored by the first storage device 130. The processes of steps S101 to S102, S104 to S122, S201 to S202, and S204 to S214 of the image reading process are performed by the control unit 421, the setting unit 422, the acquisition unit 423, the identification unit 424, the determination unit 425, the third acquisition unit 426, and the second acquisition unit 427.

In steps S101 and S201, the control unit 421 waits until the control unit 421 receives an operation signal instructing the reading of media from the second input device 201. The operation signal is output when the user inputs an instruction to read media using the second input device 201. The control unit 421 transmits the received operation signal to the image reading apparatus 100 via the second communication device 203.

In steps S102 and S202, the setting unit 422 acquires a profile included in the operation signal. The setting unit 422 sets the acquired profile in the first storage device 130 and transmits a request signal that requests to generate an input image according to the acquired profile to the image reading apparatus 100 via the second communication device 203. The setting unit 142 of the image reading apparatus 100 receives the request signal from the information processing apparatus 200 via the first communication device 122. The setting unit 142 sets the profile designated by the received request signal in the first storage device 130 and sets, for example, the imaging device 117 and the motor 121 to generate an input image corresponding to the profile. Thus, the setting unit 422 sets the profile designated by the user.

In steps S104 and S204, the control unit 421 transmits a request signal that requests to drive the motor 121 to the image reading apparatus 100 via the second communication device 203. The control unit 141 of the image reading apparatus 100 receives the request signal from the information processing apparatus 200 via the first communication device 122 and drives the motor 121 according to the received request signal. Thus, the control unit 421 feeds and conveys the media.

In steps S105 and S205, the acquisition unit 143 transmits the input image to the information processing apparatus 200 via the first communication device 122. The acquisition unit 423 acquires the input image by receiving the input image from the image reading apparatus 100 via the second communication device 203.

In step S206, the identification unit 424 stores the information pieces in the history table in the second storage device 210. In step S207, the second acquisition unit 427 acquires the information pieces by referring to the history table in the second storage device 210. In step S208, the determination unit 425 calculates the first degree of coincidence and the second degree of coincidence using the tabulation table in the second storage device 210.

In steps S110 and S210, the third acquisition unit 426 acquires multiple profiles including a profile other than the profile being set. The third acquisition unit 426 acquires the profiles by receiving the profiles from a server via the second communication device 203. The profiles may be stored in the second storage device 210 in advance, and the third acquisition unit 426 may acquire the profiles by reading out the profiles from the second storage device 210.

In steps S114 and S214, the control unit 421 transmits a request signal that requests to stop the motor 121 to the image reading apparatus 100 via the second communication device 203. The control unit 141 of the image reading apparatus 100 receives the request signal from the information processing apparatus 200 via the first communication device 122 and stops the motor 121 according to the received request signal. Thus, the control unit 421 stops the image generation process by the image reading apparatus 100 that has generated the input image.

In step S117, the control unit 421 notifies the user that the profile being set does not match the characteristic of the input image by displaying the generated notification data on the second display device 202 or by transmitting the generated notification data to another information processing apparatus 200 via the second communication device 203. In step S118, the control unit 421 receives the instruction signal from the second input device 201 or from another information processing apparatus 200 via the second communication device 203. In steps S121, the control unit 421 transmits a request signal that requests to re-drive the motor 121 to the image reading apparatus 100 via the second communication device 203. The control unit 141 of the image reading apparatus 100 receives the request signal from the information processing apparatus 200 via the first communication device 122 and re-drives the motor 121 according to the received request signal. In step S122, the control unit 421 outputs the processed image by displaying the processed image on the second display device 202.

Some of the processes performed by the units of the information processing apparatus described above may be executed by the corresponding units of the image reading apparatus.

As described above in detail, the image processing system can enhance user convenience also when the information processing apparatus performs some of the image reading processes.

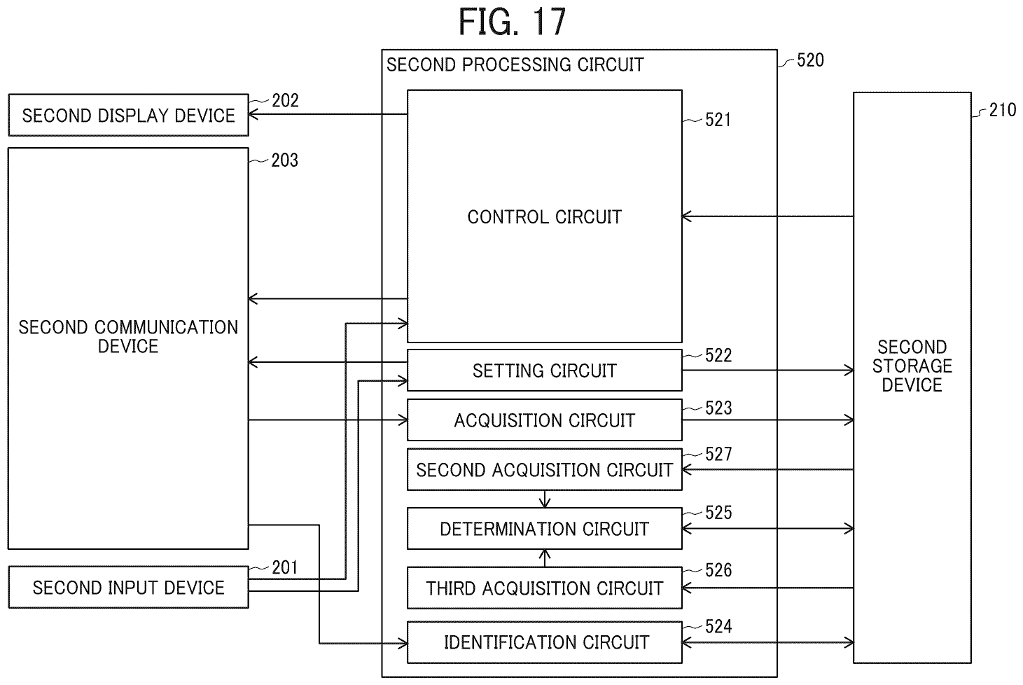

FIG. 17 is a block diagram schematically illustrating a configuration of a second processing circuit 520 in an information processing apparatus according to still another embodiment.

The second processing circuit 520 is used instead of the second processing circuit 420 and performs, for example, an image reading process. The second processing circuit 520 includes a control circuit 521, a setting circuit 522, an acquisition circuit 523, an identification circuit 524, a determination circuit 525, a third acquisition circuit 526, and a second acquisition circuit 527.

The control circuit 521 is an example of the control unit and functions in the same or substantially the same manner as the control unit 421. The control circuit 521 receives an operation signal from the second input device 201 and outputs the received operation signal to the second communication device 203. Further, the control circuit 521 reads out an input image from the second storage device 210, generates a processed image, and outputs the processed image to the second display device 202.

The setting circuit 522 is an example of the setting unit and functions in the same or substantially the same manner as the setting unit 422. The setting circuit 522 receives the profile from the second input device 201, set the profile in the second storage device 210, and outputs the profile to the second communication device 203.

The acquisition circuit 523 is an example of the acquisition unit and functions in the same or substantially the same manner as the acquisition unit 423. The acquisition circuit 523 receives the input image from the second communication device 203 and stores the input image in the second storage device 210.

The identification circuit 524 is an example of the identification unit and functions in the same or substantially the same manner as the identification unit 424. The identification circuit 524 reads out the input image from the second storage device 210, identifies characteristic information regarding the setting items in the input image, and stores the identified characteristic information in the second storage device 210.

The determination circuit 525 is an example of the determination unit and functions in the same or substantially the same manner as the determination unit 425. The determination circuit 525 reads out the characteristic information in the input image and the setting values of the setting items included in the profile from the second storage device 210. Further, the determination circuit 525 receives characteristic information pieces in the past images that were generated in the past according the profile being set from the second acquisition circuit 527. The determination circuit 525 receives multiple profiles from the third acquisition circuit 526. The determination circuit 525 determines whether the profile matches the characteristic of the input image on the basis of the information being read or received, and stores the determination result in the second storage device 210.

The third acquisition circuit 526 is an example of the third acquisition unit and functions in the same or substantially the same manner as the third acquisition unit 426. The third acquisition circuit 526 receives the profiles from the second communication device 203 or reads out the profiles from the second storage device 210, and outputs the profiles to the determination circuit 525.

The second acquisition circuit 527 is an example of the second acquisition unit and functions in the same or substantially the same manner as the second acquisition unit 427. The second acquisition circuit 527 reads out the characteristic information pieces in the past images that were generated in the past according the profile being set from the second storage device 210, and outputs the characteristic information pieces to the determination circuit 525.

As described above in detail, the information processing apparatus using the second processing circuit 520 also enhances user convenience.

Although the preferred embodiments have been described above, the embodiments are not limited thereto. For example, in step S118 of FIG. 9, the control unit 141 may receive an instruction to change the profile together with the instruction to restart the conveying and imaging of the medium. Both of the instructions are input by the user using the first input device 105 or the information processing apparatus 200. In response to receiving the instruction to restart the conveying and imaging of the medium and the instruction to change the profile, the operation proceeds to step S121, and the control unit 141 re-drives the motor 121 to re-rotate the rollers. Subsequently, in step S122, the control unit 141 performs image processing on the input image according to the profile newly designated by the user and generates a processed image. Further, the setting unit 142 sets, for example, the imaging device 117 and the motor 121 to generate an input image according to the settings indicated by the profile newly designated by the user. Accordingly, the user does not have to re-place media again on the feed table 103 to restart the conveying and imaging of the media. Thus, the image reading apparatus 100 can further enhance user convenience.

The processes of steps S106 to S121 in FIG. 8 and FIG. 9 or the processes of steps S206 to S214 and S115 to S121 in FIG. 12 and FIG. 9 do not have to be performed each time one medium is conveyed. Alternatively, these processes may be performed when the conveying of all the media placed on the feed table 103 is completed, that is, after step S124. In such a case, the processes of steps S106 to S121 or the processes of steps S206 to S214 and S115 to S121 are performed on the generated input images, and the processes of step S114 or S214 and the processes of S121 are omitted. When it is determined that the profile of at least one input image does not match the characteristic of the input image, the control unit 141 generates the notification data 1100 and outputs the generated notification data 1100. In such a case, the detailed information 1102 of the notification data 1100 indicates, for example, a recommended profile, a recommended apparatus, or recommended software for each of the input images for which it is determined that the profile does not match the characteristic of the input image. Further, all of the input images for which it is determined that the profile does not match the characteristic of the input image are displayed as the image 1103. Furthermore, the restart button 1104 is omitted.

In step S114 of FIG. 8 or step S214 of FIG. 12, the control unit 141 may stop conveying media when it is determined that the profile does not match the characteristic of the input image for a predetermined number or more of media. Alternatively, the control unit 141 may stop conveying media when it is determined that the profile does not match the characteristic of the input image for a predetermined ratio or more of media.

The processes of steps S106 to S121 of FIG. 8 and FIG. 9 or the processes of steps S206 to S214 and S115 to S121 of FIG. 12 and FIG. 9 do not have to be performed on all of the media. These processes may be performed only on a particular medium (e.g., the first medium).

In step S102 of FIG. 8 or step S202 of FIG. 12, the setting unit 142 may set, for example, the imaging device 117 and the motor 121 to generate an input image having an initial resolution that is lower than the maximum resolution supported by the image reading apparatus 100. Accordingly, the image reading apparatus 100 can convey media and capture images of the media at a high speed and can reduce the time of the image reading process. In this case, the setting unit 142 determines whether a profile currently being set has been erroneously set in the past for a medium for which an input image having a resolution higher than the resolution indicated by the profile currently being set is to be generated. In a case where such an erroneous setting of the profile is performed in the past, the setting unit 142 sets, for example, the imaging device 117 and the motor 121 to generate an input image having a resolution higher than the initial resolution. Accordingly, the image reading apparatus 100 can appropriately determine whether the profile being set matches the characteristic of the input image while reducing the processing time of the image reading process.

The determination unit 145 may determine whether the profile matches the characteristic of the input image using only a part of the input image (a part to the top side), rather than using the entire input image. In such a case, the first processing circuit 140 performs the processes of steps S106 to S121 when the acquisition unit 143 acquires the input image for a predetermined number of lines from the imaging device 117. Thus, the image reading apparatus 100 can determine earlier whether the profile matches the characteristic of the input image.

Further, the image reading apparatus may have a so-called U-turn path, feed the media placed on the feed table sequentially from the top, and discharge the media to the ejection table.

Enhancing user convenience is required in an image processing apparatus.

According to one or more embodiments of the present disclosure, an image processing apparatus, an image processing system, an image processing method, and a control program can enhance the convenience for a user.

In one aspect, a control program for controlling a computer includes a plurality of program codes, which, when executed by the computer, causes the computer to perform a method. The method includes setting a profile including a setting value of each of a plurality of setting items regarding at least one of imaging processing, image processing, or conveyance processing. The method includes acquiring an input image in which a medium is imaged. The method includes identifying a plurality of pieces of characteristic information respectively relating to the plurality of setting items in the input image. The method includes determining whether the profile matches a characteristic of the input image by comparing the plurality of pieces of characteristic information in the input image with information based on the setting value of each of the plurality of setting items included in the profile being set. The method includes notifying information regarding a determination result or stop an image generation process by an apparatus that generated the input image in a case where the determination result indicates that the profile does not match the characteristic of the input image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), and/or combinations thereof which are configured or programmed, using one or more programs stored in one or more memories to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image processing apparatus, comprising circuitry configured to:
set a profile including a setting value of each of a plurality of setting items regarding at least one of imaging processing, image processing, or conveyance processing;
acquire an input image in which a medium is imaged according to the profile;
identify a plurality of pieces of characteristic information respectively relating to the plurality of setting items in the input image;
determine whether the profile matches a characteristic of the input image by comparing the plurality of pieces of characteristic information in the input image with information based on the setting value of each of the plurality of setting items included in the profile being set; and
notify information regarding a determination result or stop an image generation process by an apparatus that generated the input image in a case where the determination result indicates that the profile does not match the characteristic of the input image.

2. The image processing apparatus of claim 1, wherein
the information based on the setting value of each of the plurality of setting items included in the profile being set is the setting value of each of the plurality of setting items included in the profile being set.

3. The image processing apparatus of claim 2, wherein
the circuitry is configured to:
calculate a degree of matching between the plurality of pieces of characteristic information in the input image and the setting value of each of the plurality of setting items included in the profile being set; and
determine whether the profile being set matches the characteristic of the input image based on whether the calculated degree of matching is equal to or greater than a threshold value.

4. The image processing apparatus of claim 1, wherein
the circuitry is further configured to acquire the plurality of pieces of characteristic information in a past image that was generated in the past according to the profile being set, and
the information based on the setting value of each of the plurality of setting items included in the profile being set is the plurality of pieces of characteristic information in the past image.

5. The image processing apparatus of claim 4, wherein
the circuitry is configured to:
acquire the plurality of pieces of characteristic information in a plurality of past images that were generated in the past according to the profile being set; and
determine whether the profile being set matches the characteristic of the input image by comparing the plurality of pieces of characteristic information in the input image with the plurality of pieces of characteristic information in the plurality of past images.

6. The image processing apparatus of claim 4, wherein
the circuitry is configured to:
calculate a degree of coincidence between the plurality of pieces of characteristic information in the input image and the plurality of pieces of characteristic information in the past image; and
determine whether the profile being set matches the characteristic of the input image depending on whether the calculated degree of coincidence is equal to or greater than a threshold value.

7. The image processing apparatus of claim 4, wherein
the circuitry is configured to determine whether the profile being set matches the characteristic of the input image further based on a result of comparison between a date and time when the input image is generated and a date and time when the past image was generated.

8. The image processing apparatus of claim 1, wherein
the circuitry is configured to:
receive a designation indicating whether the profile being set is correct after notifying the information regarding the determination result; and
in a case where the received designation indicates that the profile being set is correct, reduce a weight for subsequent determination of a particular setting item for which the circuitry determines that the characteristic information in the input image does not match information regarding the setting value included in the profile being set among the plurality of setting items.

9. The image processing apparatus of claim 1, wherein
the circuitry is further configured to:
acquire a plurality of profiles; and
determine whether the profile being set matches the characteristic of the input image further based on a result of comparison between the plurality of pieces of characteristic information in the input image and information based on the setting value of each of the plurality of setting items included in the plurality of profiles.

10. The image processing apparatus of claim 9, wherein
the circuitry is configured to notify information regarding a particular profile that most matches the plurality of pieces of characteristic information in the input image among the plurality of profiles.

11. An image processing system including an image reading apparatus and an information processing apparatus, the image processing system comprising circuitry configured to:
set a profile including a setting value of each of a plurality of setting items regarding at least one of imaging processing, image processing, or conveyance processing;
acquire an input image in which a medium is imaged according to the profile;
identify a plurality of pieces of characteristic information respectively relating to the plurality of setting items in the input image;
determine whether the profile matches a characteristic of the input image by comparing the plurality of pieces of characteristic information in the input image with information based on the setting value of each of the plurality of setting items included in the profile being set; and
notify information regarding a determination result or stop an image generation process by an apparatus that generated the input image in a case where the determination result indicates that the profile does not match the characteristic of the input image.

12. An image processing method, comprising:
setting a profile including a setting value of each of a plurality of setting items regarding at least one of imaging processing, image processing, or conveyance processing;
acquiring an input image in which a medium is imaged according to the profile;
identifying a plurality of pieces of characteristic information respectively relating to the plurality of setting items in the input image;
determining whether the profile matches a characteristic of the input image by comparing the plurality of pieces of characteristic information in the input image with information based on the setting value of each of the plurality of setting items included in the profile being set; and
notifying information regarding a determination result or stop an image generation process by an apparatus that generated the input image in a case where the determination result indicates that the profile does not match the characteristic of the input image.
